(19) United States
(12) Patent Application Publication
(10) Pub. No.: US 2013/0126794 A1
(43) Pub. Date: May 23, 2013

(54) CARBON NANOFIBER CONTAINING METAL OXIDE OR INTERMETALLIC COMPOUND, PREPARATION METHOD THEREOF, AND LITHIUM SECONDARY BATTERY USING SAME

(71) Applicants: Wan Jin Lee, Gwangju (KR); Hong Ryun Jung, Gwangju (KR)

(72) Inventors: Wan Jin Lee, Gwangju (KR); Hong Ryun Jung, Gwangju (KR)

(73) Assignee: INDUSTRY FOUNDATION OF CHONNAM NATIONAL UNIVERSITY, Gwangju (KR)

(21) Appl. No.: 13/809,155

(22) PCT Filed: Jul. 8, 2011
(86) PCT No.: PCT/KR2011/005041

§ 371 Date: Jan. 8, 2013

(30) Foreign Application Priority Data
Jul. 8, 2010 (KR) 10-2010-0065660

(51) Int. Cl. H01M 4/38; H01M 4/04

(52) U.S. Cl. CPC H01M 4/38; H01M 4/0471; Y10S 977/948; B82Y 40/00
USPC 252/506; 264/105; 264/29.2; 977/948

(57) ABSTRACT

The present invention relates to a method for preparing a carbon nanofiber in which a nano-sized metal oxide or an intermetallic compound is dispersed, and more specifically, provides a preparation method comprising the step of electrospinning a metal precursor/carbon fiber precursor solution and heat treating the same. The carbon nanofiber containing a metal oxide or an intermetallic compound can be used as an anode material for a secondary battery. According to the present invention, a secondary battery using the carbon nanofiber containing a metal oxide or an intermetallic compound as an anode material has excellent capacity, and shows excellent cycle stability, in other words, maintains a capacity of 90% or more of the initial capacity even after 100 cycles, and the like.

### REFERENCE TO RELATED APPLICATIONS

This application is a National Phase of International Application No. PCT/KR2011/005041, which was filed on Jul. 8, 2011, and which claims priority to and the benefit of Korean Patent Application No. 10-2010-0065660, filed on Jul. 8, 2010, and the disclosures of which are hereby incorporated herein by reference in their entireties.

### TECHNICAL FIELD

The present invention relates to a carbon nonofiber composite, a method of manufacturing the same, and an application thereof, and more particularly, to a carbon nonofiber containing a metal oxide or an intermetallic compound, a method of manufacturing the same, and a lithium secondary battery using the same.

### BACKGROUND ART

Recently, as there is a growing interest in a high-capacity lithium secondary battery, research on a material that can replace a black lead (graphite, 372 mAh/g) as an anode material is actively under way. In particular, tin (Sn) is a representative anode material that forms an alloy with lithium (Li) ions, and exhibits a very high theoretical capacity of 994 mAh/g by virtue of an alloying (LiₓSn (x≦4.4))-dealloying reaction between Sn and Li ions at the time of charge and discharge, and thus has been an active subject of research recently. However, the electrode material itself is apt to be brittle or electrical conductivity is rapidly decreased due to a change in volume occurring at the time of alloying (LiₓSn (x≦4.4))-dealloying of the Li ions, and thus the extent to which it exhibits a good capacity and a cycle characteristics is limited.

Although tin oxides also exhibit high theoretical capacities of 875 mAh/g (SnO) and 783 mAh/g (SnO₂), it is difficult to expect a good capacity and a cycle characteristics due to a change in volume occurring in Sn.

SnO and SnO₂ are mainly subjected to reactions over the two steps below when Li ions are inserted. In the first of the two steps, the Li ions are inserted into SnO and SnO₂, so that Li₂O is produced as in (1) and (1-1).

2Li⁺+SnO+2e⁻→Sn+Li₂O (1)

4Li⁺+SnO₂+4e⁻→Sn+2Li₂O (1-1)

xLi⁺+Sn+xe⁻→LiₓSn(x≦4.4) (2)

Although it is reported that Li₂O occurring in step (1) acts to reduce a volume expansion occurring at the time of an alloy reaction between Li ions and Sn in the next step, production of Li₂O originally exhibits a very high irreversible capacity at the first cycle. In addition, LiₓSn formed at the time of inserting the Li ions in step (2) has the same reaction as the reaction occurring with Sn only, and the change in volume due to insertion-deinsertion of the Li ions leads to a significant degradation in cycle characteristics. In order to solve the problem mentioned above, various attempts have been made to form the nano-sized tin oxide with a porous structure, an amorphous structure, or a thin film structure using a surfactant-mediated method, a sol-gel method, a reverse micro-emulsion method, and a spray pyrolysis technique. However, the methods mentioned above are also originally limited due to a low capacity much less than a theoretical capacity and cycle characteristics.

Meanwhile, efforts are under way to reduce the change in volume without an irreversible capacity by adding inert elements (M=Fe, Ni, Ca, Co, Cu, or the like) which do not react with Li to Sn and producing a SnₓM_{y} intermetallic compound. The inert elements of the intermetallic compound are relatively flexible and act as a buffer matrix as compared to a pure Li alloy metal, and can thus minimize the change in volume of an active material, thereby having better cycle stability than pure Sn. The intermetallic compounds that are mainly being researched currently are materials such as Sn₂Fe, Sn₂FeC, Cu₆Sn₅, and NiₓSn. Most such intermetallic compounds exhibit similar mechanisms, and a charge and discharge mechanism of the representative Ni₃Sn₄ is as follows.

Ni₃Sn₄+17.6Li⁺+17.6e⁻→4Li_{4.4}Sn+3Ni (1)

Li_{4.4}Sn→Sn+4.4Li⁺+4.4e⁻ (2)

Li ions are inserted into Ni₃Sn₄ to produce 4Li_{4.4}Sn with Ni being separated in step (1), and the Li ions are separated in step (2), so that a reversible activation process is caused by virtue of the charge and discharge reaction. The whole theoretical capacity from the reactions is 725 mAh/g.

As can be seen from the mechanism described above, production of the inert metal exhibits better cycle characteristics than pure Sn. However, repeating expansion and contraction during the charge and discharge reaction brings about a basic volume expansion phenomenon, and it is thus difficult to expect good cycle characteristics. Accordingly, efforts are under way to manufacture a nano-composite intermetallic electrode, and research is being conducted to manufacture an intermetallic compound for a lithium secondary battery using a spray pyrolysis method, a thin film method, a melt-spinning method, a ball-milling method, a sintering method, an E-beam evaporation method, a reductive precipitation method, an electroplating method, or the like. However, these methods are also originally limited due to a low capacity much less than a theoretical capacity and cycle characteristics.

In addition, Sn₂Fe, Sn₂FeC, Cu₆Sn₅, NiₓSn, and SnSb, which are produced by adding Fe, Ni, Ca, Co, Cu, or the like to Sn, are very difficult to manufacture as homogeneous nano-sized materials due to different atomic radii and melting points. A sintering method, a mechanical alloying method, a solvothermal method, and so forth are mainly employed as methods of producing the intermetallic compounds. However, with these methods, it is still difficult to readily manufacture the intermetallic compounds, and a noticeable capacity and cycle characteristics are not implemented.

### SUMMARY OF INVENTION

### Technical Problem

Extensive research has been conducted on replacement of graphite used as an anode material of the lithium secondary battery as described above. As a result, it is recognized that when a metal oxide-containing carbon nanofiber or an intermetallic compound-containing carbon nanofiber according to the present invention is used, the carbon nanofiber composite shows a high capacity and excellent cycle characteristics as compared to the existing anode material, graphite, thereby completing the present invention.

### Solution to Problem

In order to solve the problem described above, an aspect of the present invention provides a method of manufacturing a carbon nanofiber in which nano-sized tin oxides or copper oxides are dispersed as metal oxides.

The method of manufacturing the metal oxide-containing carbon nanofiber includes: adding a tin precursor or a copper precursor to a carbon fiber precursor material to manufacture a fiber precursor composite; spinning the fiber precursor composite to manufacture a fiber; and heat treating the fiber.

In order to solve the problem described above, another aspect of the present invention provides a method of manufacturing a carbon nanofiber in which nano-sized intermetallic compounds in which at least two metals are bonded are dispersed.

The method of manufacturing the intermetallic compound-containing carbon nanofiber includes: adding at least two metal precursors to a carbon fiber precursor material to manufacture a fiber precursor composite; spinning the fiber precursor composite to manufacture a fiber; and heat treating the fiber.

In order to solve the problem described above, yet another aspect of the present invention provides a metal oxide or the intermetallic compound-containing carbon nanofiber produced by the methods described above, and a lithium secondary battery electrode material using a composite fiber web made of the carbon nanofibers.

### Advantageous Effects of Invention

According to the present invention, nano-sized metal oxides or nano-sized intermetallic compounds which are dispersed in a carbon nanofiber can be easily manufactured, and content and size of the metal oxide or the intermetallic compound, and a diameter of the fiber can be appropriately controlled.

In addition, the metal oxide-containing carbon nanofiber according to the present invention, when used as an anode material of a lithium secondary electrode, has a very high discharge capacity after 100 cycles as compared to the commercially available anode material, graphite, and maintains 90% or more of an initial capacity for 100 cycles.

In addition, the intermetallic compound-containing carbon nanofiber according to the present invention, when used as an anode of a lithium secondary battery, exhibits a good initial specific capacity and good cycle characteristics.

In addition, the metal oxide-containing or intermetallic compound-containing carbon nanofiber can be manufactured in a fiber web state as compared to an existing case using a particle phase, so that it allows fast electromigration to be implemented, and does not need a binder, a conductive material, other solvents, facilities, or the like, and does not need processes of adding the active material, the binder, and the conductive material to a predetermined solvent to produce a slurry and carrying out coating. In addition, it has a highly expected effect as an anode material replacing the graphite in the future because it can be easily handled. Accordingly, the metal oxide-containing or intermetallic compound-containing carbon nanofiber according to the present invention is expected to be widely applied as an electrode material of a lithium secondary battery, a catalyst, and an electrode material of a solar cell.

### BRIEF DESCRIPTION OF DRAWINGS

FIG. 1A is a Scanning Electron Microscope (SEM) image of a tin oxide-containing carbon nanofiber (SnOₓ-PANPVP-700° C.) manufactured at 700° C.

FIG. 1B is an SEM image of a tin oxide-containing carbon nanofiber (SnOₓ-PANPVP-800° C.) manufactured at 800° C.

FIG. 1C is an SEM image of a tin oxide-containing carbon nanofiber (SnOₓ-PANPVP-900° C.) manufactured at 900° C.

FIG. 2A is a Transmission Electron Microscope (TEM) image of the tin oxide-containing carbon nanofiber (SnOₓ-PANPVP-700° C.) manufactured at 700° C.

FIG. 2B is a TEM image of the tin oxide-containing carbon nanofiber (SnOₓ-PANPVP-800° C.) manufactured at 800° C.

FIG. 2C is a TEM image of the tin oxide-containing carbon nanofiber (SnOₓ-PANPVP-900° C.) manufactured at 900° C.

FIG. 3A is a graph illustrating a degree of crystallization according to a temperature of the tin oxide-containing carbon nanofiber manufactured in a first example.

FIG. 3B is an X-ray absorption spectroscopy graph according to a temperature of the tin oxide-containing carbon nanofiber manufactured in a first example.

FIG. 4A is a charge and discharge result at 700° C. of the tin oxide-containing carbon nanofiber (SnOₓ-PANPVP-700° C.) manufactured in the first example.

FIG. 4B is a charge and discharge result at 800° C. of the tin oxide-containing carbon nanofiber (SnOₓ-PANPVP-800° C.) manufactured in the first example.

FIG. 4C is a charge and discharge result at 900° C. of the tin oxide-containing carbon nanofiber (SnOₓ-PANPVP-900° C.) manufactured in the first example.

FIG. 5 is a cycle characteristic result according to a temperature of the tin oxide-containing carbon nanofiber manufactured in the first example.

FIG. 6 is a Coulomb efficiency characteristic result according to a temperature of the tin oxide-containing carbon nanofiber manufactured in the first example.

FIG. 7 is an SEM image of a tin and tin oxide-containing carbon nanofiber (SnOₓ-PAN-800° C.) manufactured in a second example.

FIG. 8 is a TEM image of the tin and tin oxide-containing carbon nanofiber (SnOₓ-PAN-800° C.) manufactured in the second example.

FIG. 9 is a charge and discharge cycle result when the tin and tin oxide-containing carbon nanofiber (SnOₓ-PAN-800° C.) manufactured in the second example is used as an electrode.

FIG. 10 is a cycle characteristic result when the tin and tin oxide-containing carbon nanofiber (SnOₓ-PAN-800° C.) manufactured in the second example is used as an anode.

FIG. 11A is an SEM image of a copper oxide-containing carbon nanofiber (CuₓO-PANPVP-600° C.) manufactured at 600° C.

FIG. 11B is an SEM image of a copper oxide-containing carbon nanofiber (CuₓO-PANPVP-700° C.) manufactured at 700° C.

FIG. 11C is an SEM image of a copper oxide-containing carbon nanofiber (CuₓO-PANPVP-800° C.) manufactured at 800° C.

FIG. 11D is an SEM image of a copper oxide-containing carbon nanofiber (CuₓO-PANPVP-900° C.) manufactured at 900° C.

FIG. 12A is a TEM image of the copper oxide-containing carbon nanofiber (CuₓO-PANPVP-600° C.) manufactured at 600° C.

FIG. 12B is a TEM image of the copper oxide-containing carbon nanofiber (CuₓO-PANPVP-700° C.) manufactured at 700° C.

FIG. 12C is a TEM image of the copper oxide-containing carbon nanofiber (CuₓO-PANPVP-800° C.) manufactured at 800° C.

FIG. 12D is a TEM image of the copper oxide-containing carbon nanofiber (CuₓO-PANPVP-900° C.) manufactured at 900° C.

FIG. 13A is a graph illustrating a degree of crystallization according to a temperature of the copper oxide-containing carbon nanofiber manufactured in a third example.

FIG. 13B is an X-ray absorption spectroscopy graph according to a temperature of the copper oxide-containing carbon nanofiber manufactured in the third example.

FIG. 14A is a charge and discharge result at 600° C. of the copper oxide-containing carbon nanofiber (CuₓO-PANPVP-600° C.) manufactured in the third example.

FIG. 14B is a charge and discharge result at 700° C. of the copper oxide-containing carbon nanofiber (CuₓO-PANPVP-700° C.) manufactured in the third example.

FIG. 14C is a charge and discharge result at 800° C. of the copper oxide-containing carbon nanofiber (CuₓO-PANPVP-800° C.) manufactured in the third example.

FIG. 14D is a charge and discharge result at 900° C. of the copper oxide-containing carbon nanofiber (CuₓO-PANPVP-900° C.) manufactured in the third example.

FIG. 15 is a cycle characteristic result according to a temperature of the copper oxide-containing carbon nanofiber manufactured in the third example.

FIG. 16 is a Coulomb efficiency characteristic result according to a temperature of the copper oxide-containing carbon nanofiber manufactured in the third example.

FIG. 17 is an SEM image of a copper and copper oxide-containing carbon nanofiber (CuₓO-PAN-800° C.) that is carbonized at 800° C. and manufactured in a fourth example.

FIG. 18 is a TEM image of the copper and copper oxide-containing carbon nanofiber (CuₓO-PAN-800° C.) that is carbonized at 800° C. and manufactured in the fourth example.

FIG. 19 is a graph illustrating a degree of crystallization of the copper and copper oxide-containing carbon nanofiber (CuₓO-PAN-800° C.) that is carbonized at 800° C. and manufactured in the fourth example.

FIG. 20 is a charge and discharge result of the copper and copper oxide-containing carbon nanofiber (CuₓO-PAN-800° C.) that is carbonized at 800° C. and manufactured in the fourth example.

FIG. 21 is a cycle characteristic result of the copper and copper oxide-containing carbon nanofiber (CuₓO-PAN-800° C.) that is carbonized at 800° C. and manufactured in the fourth example.

FIG. 22 is a Coulomb efficiency result of the copper and copper oxide-containing carbon nanofiber (CuₓO-PAN-800° C.) that is carbonized at 800° C. and manufactured in the fourth example.

FIG. 23A is an SEM image of a Ni₃Sn₂-containing carbon nanofiber manufactured at 600° C.

FIG. 23B is an SEM image of a Ni₃Sn₂-containing carbon nanofiber manufactured at 700° C.

FIG. 23C is an SEM image of a Ni₃Sn₂-containing carbon nanofiber manufactured at 800° C.

FIG. 24 is a graph illustrating a degree of crystallization according to a temperature of the Ni₃Sn₂-containing carbon nanofiber manufactured in a fifth example.

FIG. 25A is a charge and discharge result at 600° C. of the Ni₃Sn₂-containing carbon nanofiber manufactured in the fifth example.

FIG. 25B is a charge and discharge result at 700° C. of the Ni₃Sn₂-containing carbon nanofiber manufactured in the fifth example.

FIG. 25C is a charge and discharge result at 800° C. of the Ni₃Sn₂-containing carbon nanofiber manufactured in the fifth example.

FIG. 26 is a graph illustrating a cycle according to each temperature of the Ni₃Sn₂-containing carbon nanofiber manufactured in the fifth example.

FIG. 27 is a Coulomb efficiency according to a temperature of the Ni₃Sn₂-containing carbon nanofiber manufactured in the fifth example.

FIG. 28A is an SEM image of a Cu₆Sn₅-containing carbon nanofiber manufactured at 700° C.

FIG. 28B is an SEM image of a Cu₆Sn₅-containing carbon nanofiber manufactured at 800° C.

FIG. 28C is an SEM image of a Cu₆Sn₅-containing carbon nanofiber manufactured at 900° C.

FIG. 29 is a graph illustrating a degree of crystallization according to a temperature of the Cu₆Sn₅-containing carbon nanofiber manufactured in the fifth example.

FIG. 30 is a charge and discharge graph of the Cu₆Sn₅-containing carbon nanofiber manufactured in the fifth example.

FIG. 31 is a cycle characteristic of the Cu₆Sn₅-containing carbon nanofiber manufactured in the fifth example.

FIG. 32 is a Coulomb efficiency of the Cu₆Sn₅-containing carbon nanofiber manufactured in the fifth example.

FIG. 33 is an SEM image of a SnSb-containing carbon nanofiber manufactured in the fifth example.

FIG. 34 is a degree of crystallization of the SnSb-containing carbon nanofiber manufactured in the fifth example.

FIG. 35 is a charge and discharge graph of the SnSb-containing carbon nanofiber manufactured in the fifth example.

FIG. 36 is a cycle characteristic of the SnSb-containing carbon nanofiber manufactured in the fifth example.

FIG. 37 is a Coulomb efficiency of the SnSb-containing carbon nanofiber manufactured in the fifth example.

### BEST MODE OF CARRYING OUT THE INVENTION

Hereinafter, preferred embodiments of the present invention will be described in detail. However, the present invention is not limited to the embodiments to be described below.

A method of manufacturing a metal oxide-containing carbon nanofiber according to an embodiment of the present invention includes: adding a tin precursor or a copper precursor to a carbon fiber precursor material to manufacture a fiber precursor composite; spinning the fiber precursor composite to manufacture a fiber; and heat treating the fiber. In addition, the method may further include carbonizing the heat treated fiber and activating the carbonized fiber.

The tin precursor may be a tin nitrate, a tin chloride salt, a tin acetate, a tin alkoxide, or a mixture thereof, and preferably, the tin acetate.

The copper precursor may be a copper nitrate, a copper chloride salt, a copper acetate, a copper alkoxide, or a mixture thereof, and preferably, the copper acetate.

In addition, the carbon nanofibers may be in the form of a composite fiber web in which tin oxides or copper oxides are evenly dispersed.

In particular, a method of manufacturing a composite fiber web made of the tin oxide or copper oxide-containing carbon nanofibers may include:

a) adding a tin precursor or a copper precursor to a carbon fiber precursor material to produce a fiber precursor composite (where the tin precursor or the copper precursor is added to have the tin oxide or copper oxide with a ratio of 10 to 50 weight % in a residue of the final carbon nanofiber);

b) manufacturing the composite fiber web with the nanofibers produced by injecting the fiber precursor composite into a syringe with a needle, applying a voltage and carrying out electrospinning thereon; and

c) increasing a temperature of the fiber web from room temperature to a temperature of 220° C. to 300° C. by 0.1° C. to 10° C. per minute, and heat treating the fiber web for 0.5 to 5 hours at the final temperature.

In addition, the method of manufacturing the fiber web may further include carbonizing the heat treated fiber web at 300° C. to 3000° C. in an inert atmosphere or a vacuum state, and activating the carbonized fiber web.

In this case, the copper oxide may include at least any one selected from Cu₂O, CuO, Cu₂O₃, CuO₂ and Cu₃O₄, and preferably, may include at least any one of Cu₂O and CuO.

A method of manufacturing an intermetallic compound-containing carbon nanofiber according to another embodiment of the present invention includes adding at least two metal precursors to a carbon fiber precursor material to produce a fiber precursor composite; spinning the fiber precursor composite to produce a fiber; and heat treating the fiber. In addition, the method may further include carbonizing the heat treated fiber, and activating the carbonized fiber.

The metal precursors may be at least two selected from the group consisting of metal precursors containing tin (Sn), antimony (Sb), copper (Cu), nickel (Ni), iron (Fe), cobalt (Co), titanium (Ti), magnesium (Mg), manganese (Mn), calcium (Ca), zinc (Zn), indium (In), molybdenum (Mo), tungsten (W), aluminum (Al), and silicon (Si) ions. Preferably, the metal precursor may be at least two selected from the metal precursors containing tin (Sn), copper (Cu), antimony (Sb), or nickel (Ni) ions, and more preferably, may be at least two selected from tin (I) acetate, copper (II) acetate, antimony (III) acetate, and nickel (II) acetate.

In addition, the carbon nanofibers may be in the form of a composite fiber web in which the intermetallic compounds are evenly dispersed.

In particular, a method of manufacturing a composite fiber web made of the intermetallic compound-containing carbon nanofiber may includes:

a) adding at least two metal precursors to a carbon fiber precursor material to produce a fiber precursor composite (where the at least two metal precursors are added to have the intermetallic compound with a ratio of 10 to 50 weight % in a residue of the final carbon nanofiber);

b) manufacturing the composite fiber web with the nanofibers produced by injecting the fiber precursor composite into a syringe with a needle, applying a voltage and carrying out electrospinning thereon; and

c) increasing a temperature of the fiber web from room temperature to a temperature of 220° C. to 300° C. by 0.1° C. to 10° C. per minute, and then heat treating the fiber web for 0.5 to 5 hours at the final temperature.

In addition, the method of manufacturing the fiber web may further include carbonizing the heat treated fiber web at 300° C. to 3000° C. in an inert atmosphere or a vacuum state, and activating the carbonized fiber web.

In the methods described above, the fiber precursor composite that is a starting material is produced by adding a tin precursor, a copper precursor, or at least two metal precursors to the carbon fiber precursor material to be a fiber precursor polymer solution. In this case, the carbon fiber precursor material includes any one or a mixture of at least two selected from a group consisting of polyacrylonitrile, polyfurfuryl alcohol, cellulose, glucose, polyvinyl chloride, polyacrylic acid, polylactic acid, polyethylene oxide, polypyrrole, polyimide, polyamide imide, polyaramide, polybenzimidazole, polyaniline, phenol resin, and pitch, and more preferably, may include the polyacrylonitrile resin.

In addition, the fiber precursor composite may further include a polyvinylpyrrolidone based resin. Here, in the case of the fiber precursor composite to which the tin precursor, the copper precursor or at least two metal precursors are added, a weight ratio between the carbon fiber precursor material and the polyvinylpyrrolidone based resin to be mixed is preferably 90 to10:10 to 90 weight %, and more preferably, 50:50 weight %.

As the carbon fiber precursor material used in the present invention, a mixture of any typical synthetic polymer and the carbon precursor described above may be employed. In this case, when the polyacrylonitrile resin is used, a viscosity of the fiber precursor composite is decreased when a weight-average molecular weight is less than 50,000 and is increased when the weight-average molecular weight exceeds 500,000, which is not preferable.

The polyvinylpyrrolidone based resin is a compound in which oxygen can be bonded with a metallic cation of the metal precursor at the time of heat treatment through mutual reaction to allow a cation complex compound to be produced and to keep good miscibility, and may be any typical synthetic polymer. The polyvinylpyrrolidone based resin preferably has a weight-average molecular weight of 40,000 to 1,500,000, and more preferably has the weight-average molecular weight of 70,000 to 1,300,000. The viscosity of the fiber precursor composite is decreased when the weight-average molecular weight is less than 40,000 and is increased when the weight-average molecular weight exceeds 1,500,000, which is not preferable.

In addition, a material that can replace the polyvinylpyrrolidone based resin may include a compound having an oxygen atom as a donor atom. The compound having the oxygen atom as the donor atom includes any one or more functional groups selected from RO—, —C═O—, —CO—, —SO—, —O—R—CO—, —O—R—O—, —OC—R—CO—, —NH—R—CO—, and —NH—R—O— within a molecule, and may be replaced by a compound including an oleic acid or a glyceride. In this case, R may be an alkyl group of C1 to C20, or an aryl group or a substituted aryl group of C6 to C20.

In the present invention, the polyvinylpyrrolidone based resin may be preferably used as a dispersant of the metal oxide or intermetallic compound within the carbon nanofiber in terms of a non-toxic property and cost saving.

A mixing ratio of the polyvinylpyrrolidone based resin to be added is suitable in a range of 10 to 90 weight %, and preferably, 50 weight %. The metal precursor cannot be easily dissolved when the ratio is less than the lower limit of the range and a carbon yield is low when the ratio exceeds the upper limit of the range, which is not preferable.

A solvent that can be used in the present invention may include dimethylformamide (DMF), dimethylacetamide (DMAc), tetrahydrofuran (THF), dimethylsulfoxide (DMSO), gamma-butyrolactone, N-methylpyrrolidone, chloroform, toluene, acetone, or a mixture thereof as a polar solvent other than water in which the resin can be dissolved. Preferably, at least one from dimethylformamide (DMF), dimethylacetamide (DMAc), and tetrahydrofuran (THF) may be selected.

It is preferable to produce the fiber precursor polymer solution with a solvent of 95 to 50 weight % and a polymer of 5 to 50 weight %. Using a solid polymer within the range may prevent a physical property from being degraded by virtue of uniform dispersion. In addition, the metal precursor is added to be 5 to 100 parts by weight of an amount of carbon in consideration of the amount of carbon remaining after burn-off and the final carbon nanofiber yield.

In a preferable aspect, a polyacrylonitrile polymer and a polyvinylpyrrolidone based resin are quantified with a ratio of 90 to 10 weight %:10 to 90 weight %, and are dissolved to have a polymer resin with about 5 to 50 weight %, preferably, 6 to 10 weight % in a solvent. Heat is then applied at a temperature of 100 to 150° C. to completely dissolve the polymer resin in the solvent and cool the polymer solution to room temperature, and one kind of metal precursor (a tin precursor or copper precursor) is added or at least two selected kinds of metal precursors are mixed and added at a suitable mole ratio. In this case, the whole amount of carbon is made to be 90 to 50% and the amount of the metal particle is made to be 10 to 50% in consideration of the yield of carbon after final burn-off.

The most important factor at the time of manufacturing the nanofiber using electrospinning is a suitable viscosity of the composite. The viscosity tends to increase when the metal precursor is added to the solution of the mixed polymer. In view of this, the viscosity of the composite is low when the content of the polymer is less than 5 weight % and is high when the content exceeds 30%, which is not suitable for the spinning at the time of manufacturing the nanofiber.

The produced composite is subjected to heating again to be homogenized and is put into a syringe with a needle, and electrospining is carried out by applying a voltage of 1 to 50 kV, preferably 20 to 30 kV thereon to produce a fiber. A temperature is increased up to 220 to 300° C., and heat treatment of the produced fiber is carried out thereon for 0.5 to 10 hours under an air atmosphere for stabilization of spun nanofiber.

The heat treatment process is a process by which a thermoplastic resin is transformed into a thermosetting resin to oxidize a surface of the fiber to prevent fusion and melting in subsequent high-temperature carbonization and activation processes. The thermoplastic resin is usually melted or fused between fibers when it is carbonized and activated at a high temperature. To prevent this, the heat treatment that is an oxidative stabilization process is carried out to transform the thermoplastic resin into the thermosetting resin. When the carbonization and the activation are carried out without the heat treatment process, an exothermic reaction such as ring opening, dehydrogenation, or the like progresses rapidly and causes the thermoplastic resin to be combusted rather than carbonized. In view of this, the heat treatment process of the present invention forms cross-linking or strong hydrogen bonding with oxygen to enable volatile materials to be decreased and a solid carbonization reaction to occur in subsequent high-temperature carbonization and activation processes, thereby keeping the dimensions and structure of the fiber even during the carbonization.

In the carbonization process of the present invention, after the heat treatment is carried out in order to keep the dimensions and structure of the fiber, a raw material is heated again at a high temperature under specific conditions in order to remove volatile non-carbon components. In this case, the temperature and time of the carbonization may be arbitrarily set. In particular, the heat treated fiber may be carbonized at 300 to 3000° C. in an inert atmosphere or a vacuum state to manufacture the carbon nanofiber in which nano-sized metal oxides or intermetallic compounds are contained.

The metal oxide or intermetallic compound-containing carbon nanofiber and its characteristics resulting from the embodiments of the present invention are as follows.

The tin oxide-containing carbon nanofiber has diameters of 50 to 300 nm, an average diameter of 175 nm, and 1 to 40 nm sized tin oxides that are evenly dispersed inside and on the surface of the carbon nanofiber.

The tin oxide-containing carbon nanofiber, when used as an anode of a lithium secondary battery, exhibits a good capacity and cycle characteristics by having a discharge capacity of about 649 mAh/g after 100 cycles and keeping at least 90% of its initial capacity.

The copper oxide-containing carbon nanofiber has diameters of 10 to 200 nm, an average diameter of 150 nm, and 1 to 50 nm sized copper oxides that are evenly dispersed inside and on the surface of the carbon nanofiber. The copper oxide-containing carbon nanofiber, when used as an anode of a lithium secondary battery, exhibits a good capacity and cycle characteristics by having a discharge capacity of about 470 mAh/g after 100 cycles and keeping at least 90% of its initial capacity.

The intermetallic compound-containing carbon nanofiber has diameters of 150 to 500 nm, an average diameter of 200 nm, and 2 to 60 nm sized intermetallic compounds that are evenly dispersed inside and on the surface of the carbon nanofiber.

In addition, the intermetallic compound-containing carbon nanofiber includes not only the intermetallic compounds but also a carbon nanofiber in which metal oxides are dispersed as by-products thereof.

The intermetallic compound-containing carbon nanofiber, when used as an anode of a lithium secondary battery, exhibits a good capacity and cycle characteristics by having an initial specific capacity of 630 mAh/g for the Ni₃Sn₂/carbon nanofiber, 500 mAh/g for Cu₆Sn₅, and 780 mAh/g for SnSb, and keeping at least 90% of its initial capacity for 100 cycles.

Hereinafter, preferred examples will be described in order to help understand the present invention. However, the following examples are merely to help understand the present invention, and the present invention is not limited to these examples.

A method of measuring the physical properties that is employed in the following examples is as follows.

A diameter distribution and a surface image were measured using an SEM (FE-SEM, Hitachi, S-4700).

A degree of dispersion of the metal oxides or the intermetallic compounds was measured using a TEM (FE-TEM, JEM-2000 FXII JEOL, USA).

A degree of crystallization and a fine structure analysis of the metal oxides or the intermetallic compounds were measured using X-ray diffraction analysis (XRD, D/MAX Uitima, Rigaku, Japan) and X-ray absorption spectroscope (Extended Xray Absorption Fine Structure (EXAFS), Pohang Accelerator Laboratory, Korea).

A charge and discharge capacity and a cycle characteristic as an anode of a lithium secondary battery were measured using a coin cell made of a lithium (Li) metal/separator/metal oxide or intermetallic compound-containing carbon nanofiber and an EC:DMC liquid electrolyte of LiPF₆ 1:1 vol %.

A charge and discharge experiment was conducted on the coin cell using a charge and discharge device

<Manufacturing Tin Oxide-Containing Carbon Nanofiber and Analyzing Characteristics Thereof>

### FIRST EXAMPLE

0.4 g of a polyacrylonitrile resin (weight-average molecular weight: 150,000) and 0.4 g of a polyvinylpyrrolidone resin (molecular weight: 1,300,000) were added to a 9 g N,N-dimethylformamide solvent and were dissolved for 5 hours at 120° C. to produce a polymer solution (A). 0.1097 g of a tin acetate (molecular weight: 236.78) was added to the polymer solution (A) at room temperature and was agitated for 5 hours at 120° C. again.

The homogenized tin acetate/polyacrylonitrile/polyvinylpyrrolidone solution was electrospun using an electrospinning device. In this case, the spinning conditions were such that the fiber precursor solution was introduced into a 10 ml syringe with a 0.5 mm needle and the electrospinning was carried out by applying a voltage of 20 kV. In this case, a distance between the needle and the current collector was maintained at 17 cm, an elution speed of the fiber precursor solution was 1 ml/h, and the non-woven fabric was removed when the fibers were integrated in the current collector.

The separated fiber web made of the tin acetate/polyacrylonitrile/polyvinylpyrrolidone was subjected to heat treatment for 5 hours under an air atmosphere at 280° C. In this case, the temperature was increased by 1° C. per minute and was maintained at 280° C. for 5 hours. The carbonization process was then carried out for 1 hour at each of 700° C., 800° C., and 900° C.

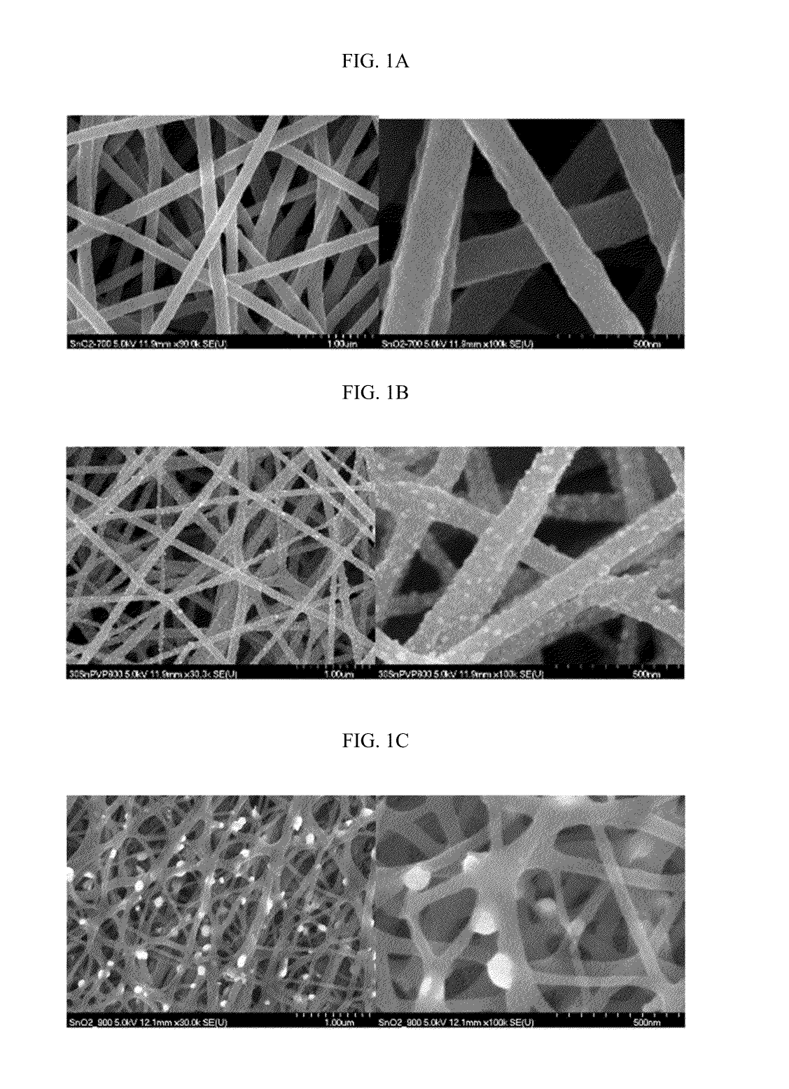

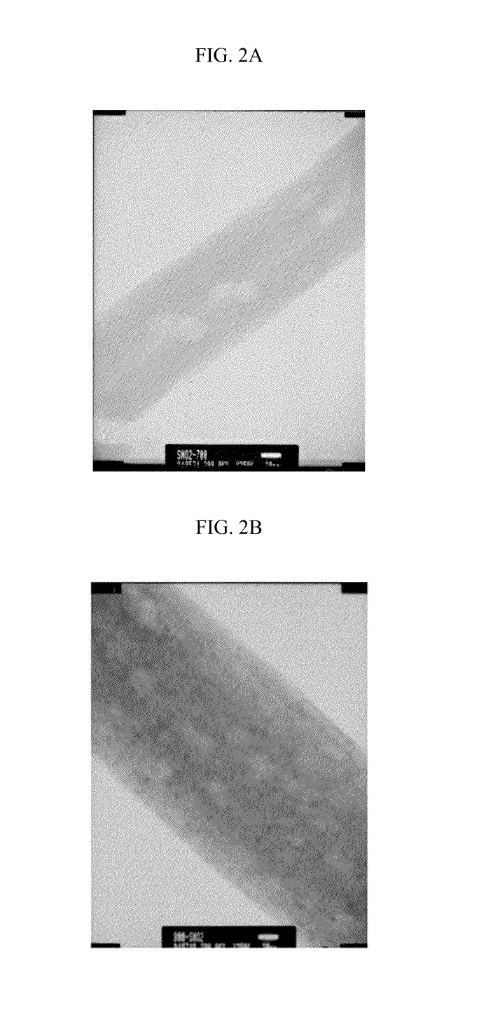

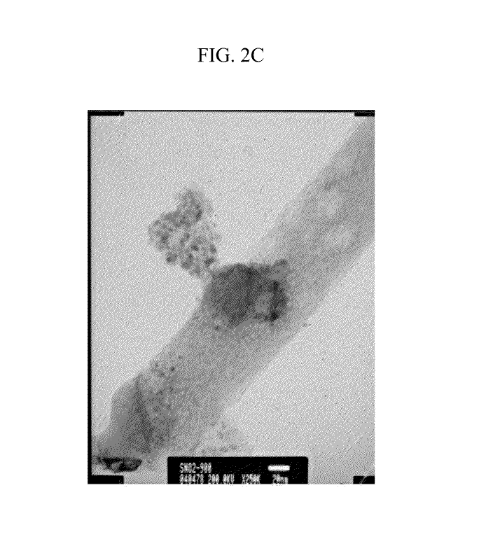

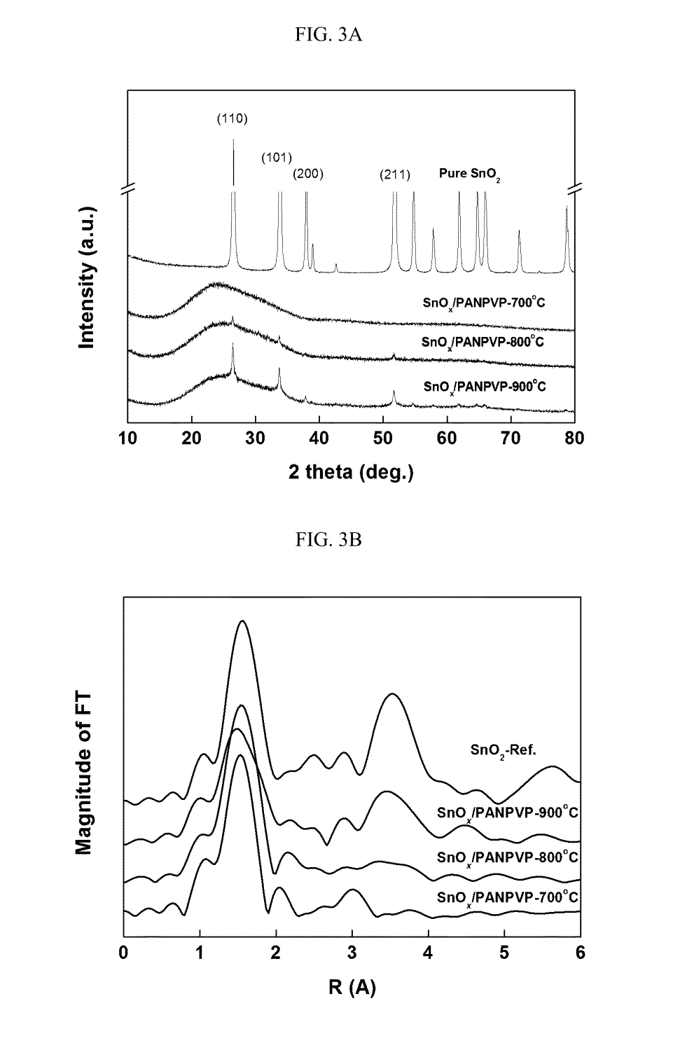

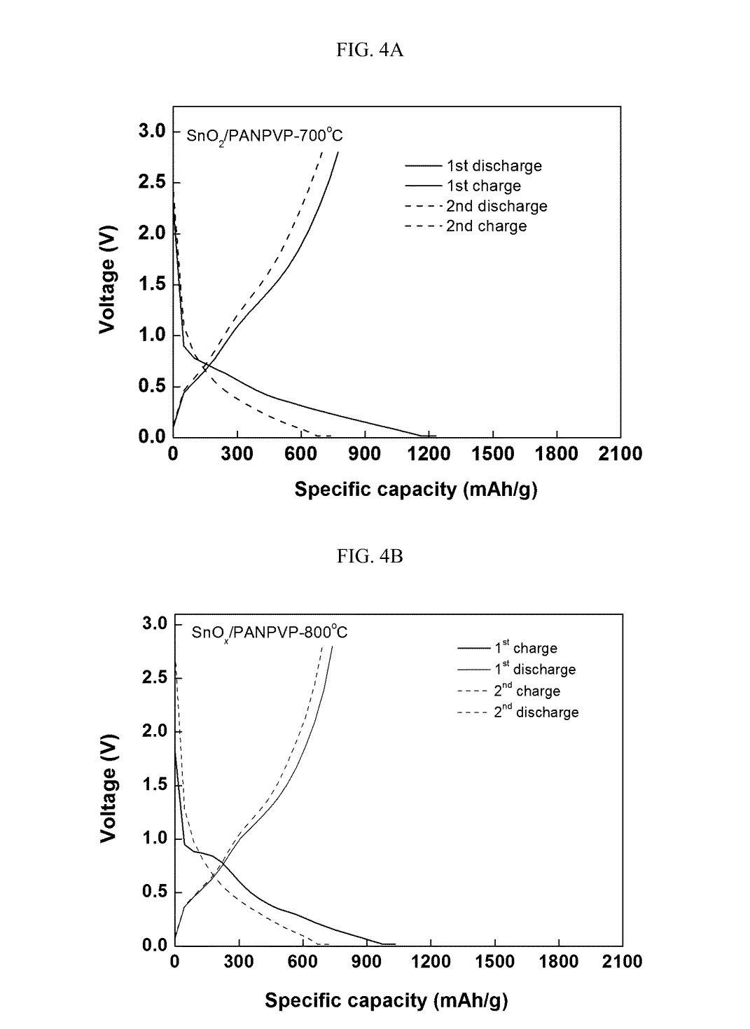

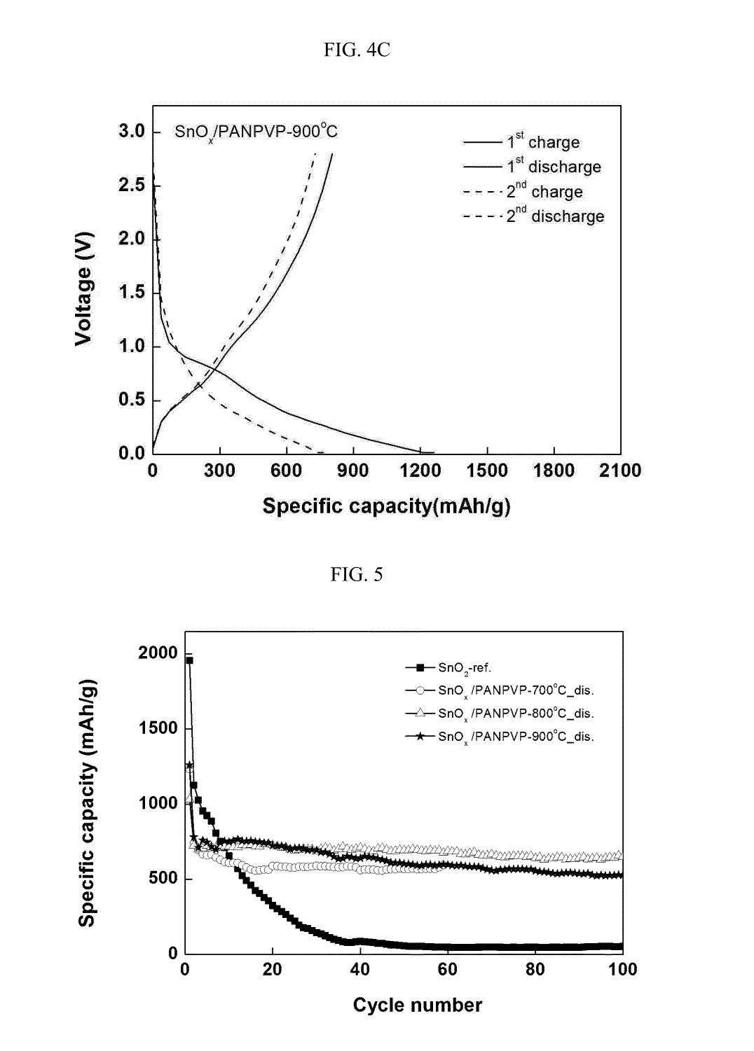

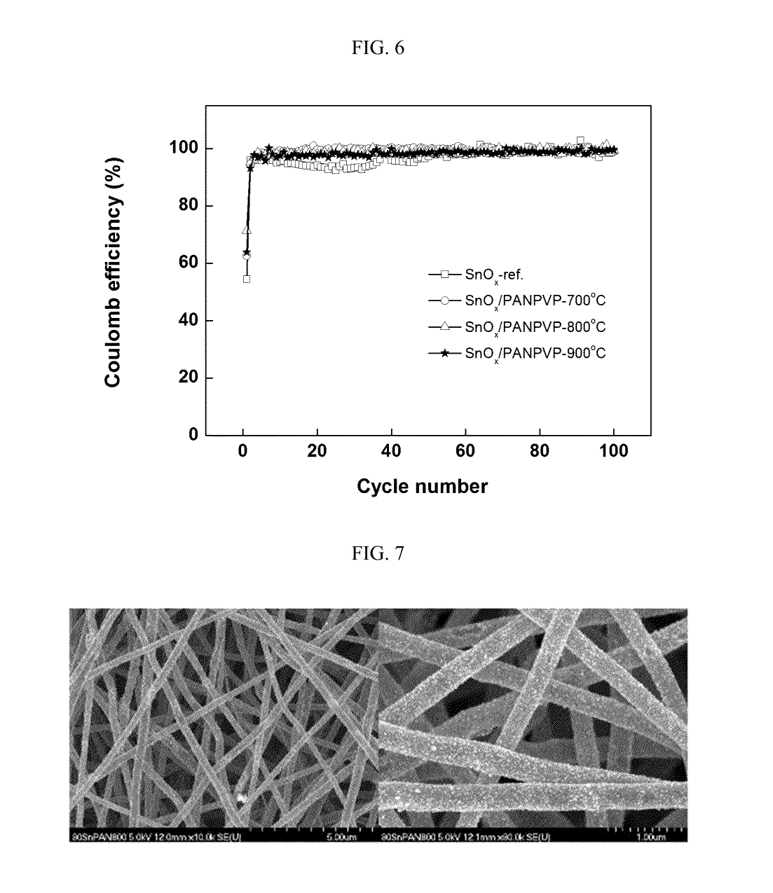

SEM images of the tin oxide-containing carbon nanofiber manufactured at each of the temperatures described above are shown in FIGS. 1A, 1B, and 1C. In addition, TEM images of the tin oxide-containing carbon nanofiber are shown in FIG. 2, a degree of crystallization of the tin oxide-containing carbon nanofiber is shown in FIG. 3A, and a fine structure analysis thereof is shown in FIG. 3B. FIGS. 4A, 4B, and 4C show the charge and discharge results of an electrode when the tin oxide-containing carbon nanofiber was used as the electrode. In addition, FIG. 5 shows cycle characteristics when the tin oxide-containing carbon nanofiber was used as an anode, and FIG. 6 shows a Coulomb efficiency.

### SECOND EXAMPLE

0.8 g of a polyacrylonitrile resin (weight-average molecular weight: 150,000) was added to a 9 g N,N-dimethylformamide solvent and was dissolved for 5 hours at 120° C. to produce a polymer solution (B). 0.2188 g of a tin acetate was added to the polymer solution (B) at room temperature and was agitated for 5 hours at 120° C. again.

The homogenized tin acetate/polyacrylonitrile polymer solution was electrospun using an electrospinning device. Hereinafter, the electrospinning conditions are the same as those in the first example.

The separated fiber web made of the tin acetate/polyacrylonitrile was subjected to heat treatment for 5 hours under an air atmosphere at 280° C. In this case, the temperature was increased by 1° C. per minute and was maintained at 280° C. for 5 hours.

After the heat treatment, the carbonization process was carried out for 1 hour at 800° C.

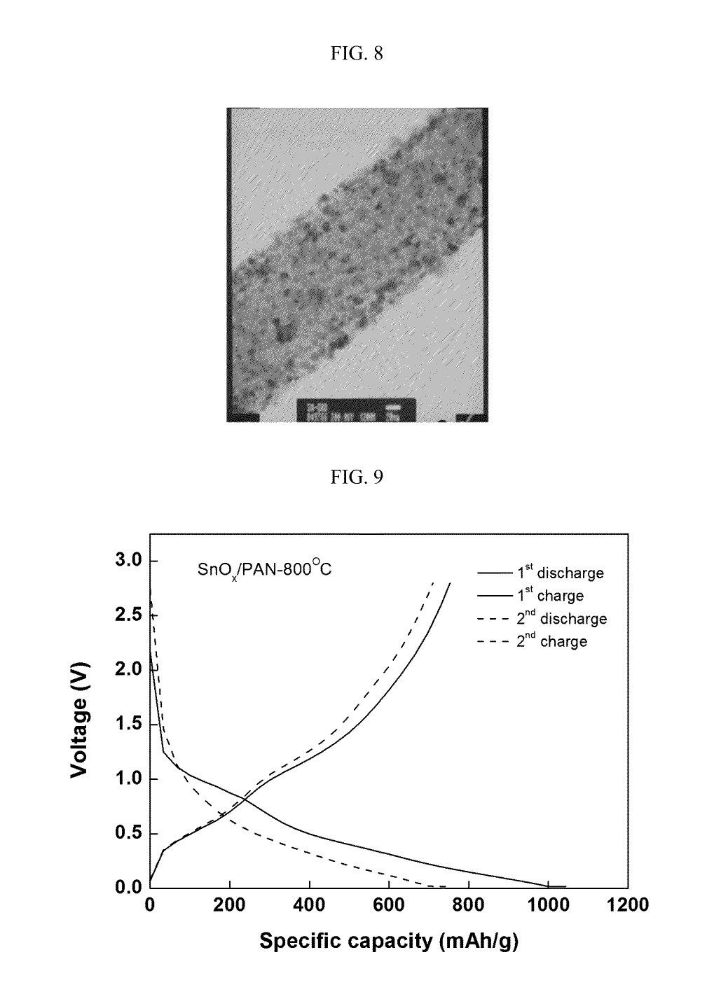

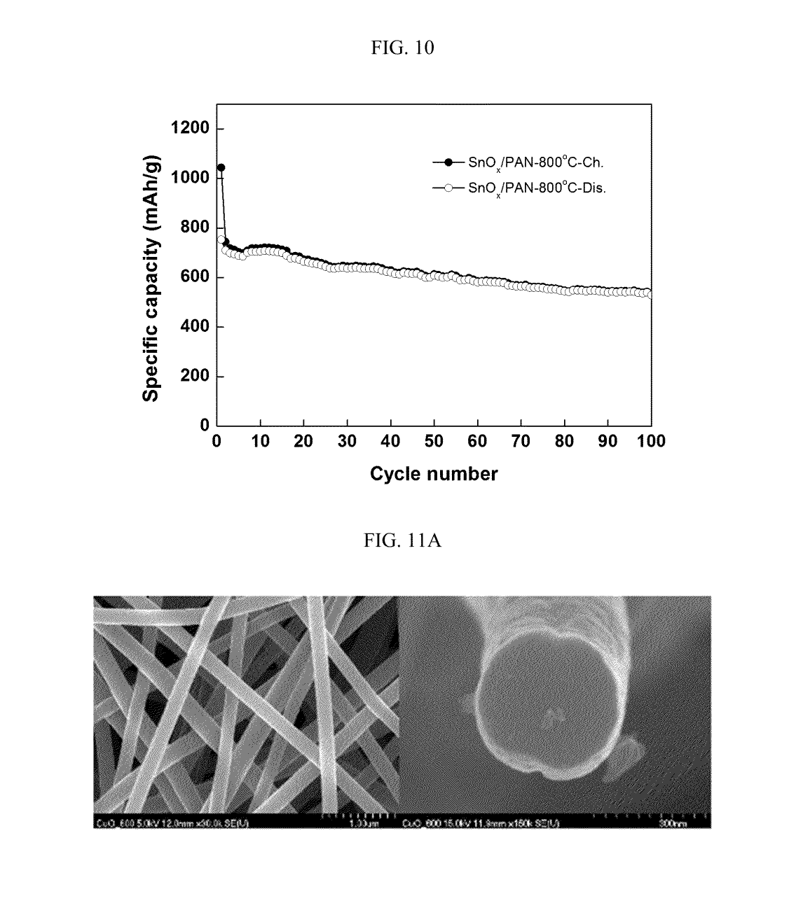

The SEM image of the tin and tin oxide-containing carbon nanofiber (SnOₓ-PAN-800° C.) manufactured as described above is shown in FIG. 7. In addition, the TEM image of the tin and tin oxide-containing carbon nanofiber is shown in FIG. 8, the charge and discharge cycle characteristics of an electrode when the tin and tin oxide-containing carbon nanofiber was used as the electrode are shown in FIG. 9. In addition, FIG. 10 shows a cycle characteristic when the tin and tin oxide-containing carbon nanofiber was used as an anode.

As shown in FIGS. 1A, 1B, and 1C, it was found that a diameter of the fiber was 200 nm at 700° C. and was decreased when the temperature was increased. An average diameter of the tin oxide-containing carbon nanofiber produced by the methods of the present invention was about 175 nm, and a range of the fiber diameter was 50 to 300 nm. It can be seen that the diameter of the fiber is one fiftieth or less of the diameter of about 10 μm of the fiber produced by a general fiber manufacturing method such as a melt spinning method, a gel state spinning method or the like, and the fiber is produced as a superfine fiber thinner than an active carbon nanofiber produced by spinning polyacrylonitrile only. In addition, it was found that the tin oxide structure did not develop well within the carbon nanofiber at 700° C. and developed on a surface of the fiber at 800° C. In addition, it was found that the dispersed nano-sized tin oxides were aggregated at 900° C.

FIG. 2A shows the TEM image of the tin oxide-containing carbon nanofiber manufactured at 700° C., and it can be seen that the tin oxides of 2 nm or less are minutely dispersed within the carbon nanofiber. FIGS. 2B and 2C show TEM images of the tin oxide-containing carbon nanofiber manufactured at 800° C. and 900° C., respectively. It was also found that sizes of the tin oxides were as small as 4 nm or less and 40 nm or less as shown in FIGS. 2B and 2C, respectively, and the dispersions were also good. It was thus found that a suitable temperature was applied in order to appropriately disperse the tin oxides within the carbon fiber. Although research has been actively conducted so far on manufacturing the anode material of the non-carbon based lithium secondary battery such as Sn, Si, Ag, Bi, SnOₓ, Cu₂O, Fe₂O₃, CO₃O₄, or the like in a nano size form or a thin film form, there is no method of highly dispersing the tin oxides within the carbon nanofiber as is done in the method of the present invention. In addition, by using the tin oxide-containing carbon nanofiber as the anode material of the lithium secondary battery, problems occurring on the tin oxide were completely overcome.

As shown in FIG. 3A, it can be seen that the degree of crystallization is changed depending on the temperature and is increased as the temperature is increased. In addition, it can be seen that a magnitude of the peak indicating the degree of crystallization of the tin oxide-containing carbon nanofiber is very small as compared to the pure tin oxide (SnO₂). This means that the carbon nanofiber prevents the tin oxides from being aggregated. However, the X-ray diffraction analysis provides information only on the crystallization, and it is thus necessary to employ the fine structure analysis using the X-ray absorption spectroscope along with the X-ray diffraction analysis in order to know the exact structure of the tin oxides dispersed in a size of several nanometers within the carbon nanofiber. It was confirmed as a result of the X-ray absorption fine structure analysis that the disordered tin oxides were formed within the carbon nanofiber when the tin oxide-containing carbon nanofiber was produced at 700° C. and the tin oxide was developed to a disordered structure having an octahedral shape consisting of six oxygen (O₂⁻) atoms around the tin (Sn^{IV}) atom at 800° C. In addition, it was confirmed that the disordered degree was decreased when the tin oxide-containing carbon nanofiber was produced at 900° C. to be almost similar to be a structure of the pure tin oxide.

FIGS. 4 and 5 show the charge and discharge result and the cycle characteristic when the tin oxide-containing carbon nanofiber produced at each temperature was used as an anode of the secondary battery. As can be seen from the charge and discharge results, the tin oxide-containing carbon nanofiber produced at 800° C. has the smallest irreversible capacity for 100 cycles of charge and discharge. This seems to be because the particle size of the tin oxide is small and the carbon nanofiber keeps the electrical conductivity even when Li₂O is created by inserting the Li ions into the tin oxide to exhibit the best cycle characteristic.

FIG. 6 shows the Coulomb efficiency, and the metal oxide-containing carbon nanofiber produced at 800° C. also exhibits the best Coulomb efficiency at the first cycle, which is the same as described above.

FIG. 7 shows the SEM imgae of the tin and tin oxide-containing carbon nanofiber (SnOx-PAN-800° C.) produced by electrospinning the tin acetate/polyacrylonitrile solution and then heat treating and carbonizing the same at 800° C. In this case, it was confirmed that the diameter of the tin and tin oxide-containing carbon nanofiber manufactured as described above was 250 nm, which is greater than a diameter of the sample produced by adding polyvinylpyrrolidone and carrying out spinning.

In addition, it can be seen that particles of the oxide in a case of the tin and tin oxide-containing carbon nanofiber are large enough to be present inside and outside the carbon nanofiber as shown in the TEM imgae of FIG. 8, which means that the sample produced by adding polyvinylpyrrolidone acts to more evenly disperse the tin oxide particles within the carbon nanofiber.

FIG. 9 shows the charge and discharge cycle characteristics of the tin and tin oxide-containing carbon nanofiber produced by mixing tin acetate and polyacrylonitrile. Referring to FIGS. 9 and 10, it can be found that the carbon nanofiber produced by adding polyacrylonitrile only has the relatively big tin and tin oxide particles and thus has degraded cycle characteristics as compared to the tin oxide-containing carbon nanofiber produced by adding polyvinylpyrrolidone when the nanofiber is used as an anode. As described above, it can be concluded that electrochemical sites are increased by highly dispersing the tin oxides, the electrical conductivity of the carbon nanofiber is kept even when Li₂O is created during the charge and discharge procedure, and the aggregation of the tin oxides is buffered, so that the electrochemical property is very good.

Accordingly, it can be seen that it is possible to manufacture the tin oxide-containing carbon nanofiber having good enough electrochemical characteristics to replace the existing graphite as an anode of the lithium secondary battery by adjusting whether a compound having an oxygen atom as a donor atom such as polyvinylpyrrolidone needs to be added, a content of the carbon precursor material and the compound at the time of electrospinning, and a content of the tin precursor in accordance with an aspect of the embodiments.

<Manufacturing Copper Oxide-Containing Carbon Nanofiber and Analyzing Characteristics Thereof>

### THIRD EXAMPLE

0.4 g of a polyacrylonitrile resin (weight-average molecular weight: 150,000) and 0.4 g of a polyvinylpyrrolidone resin (molecular weight: 1,300,000) were added to a 9 g N,N-dimethylformamide solvent and were dissolved for 5 hours at 120° C. to produce a polymer solution (A). 0.1572 g of a copper (II) acetate (molecular weight: 181.64) was added to the polymer solution (A) at room temperature and was agitated for 3 hours at 120° C. again.

The homogenized copper (II) acetate/polyacrylonitrile/polyvinylpyrrolidone solution was electrospun using an electrospinning device. In this case, the spinning conditions were such that the fiber precursor solution was introduced into a 10 ml syringe with a 0.5 mm needle and the electrospinning was carried out by applying a voltage of 20 kV. In this case, a distance between the needle and the current collector was maintained at 17 cm, an elution speed of the fiber precursor solution was 1 ml/h, and the non-woven fabric was removed when the fibers were integrated in the current collector.

The separated fiber web made of the copper (II) acetate/polyacrylonitrile/polyvinylpyrrolidone was subjected to heat treatment for 5 hours under an air atmosphere at 230° C. In this case, the temperature was increased by 1° C. per minute and was maintained at 230° C. for 5 hours.

After the oxidative stabilization was sufficiently carried out, the carbonization process was carried out for 1 hour at each of 600° C., 700° C., 800° C., and 900° C.

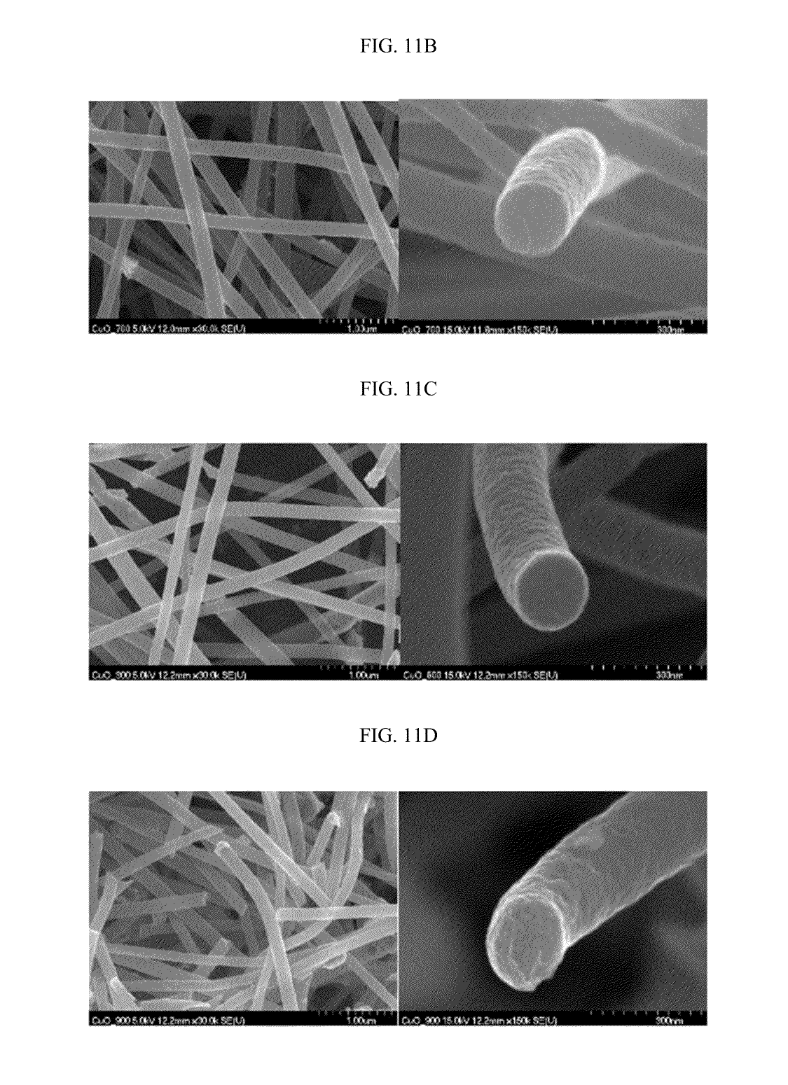

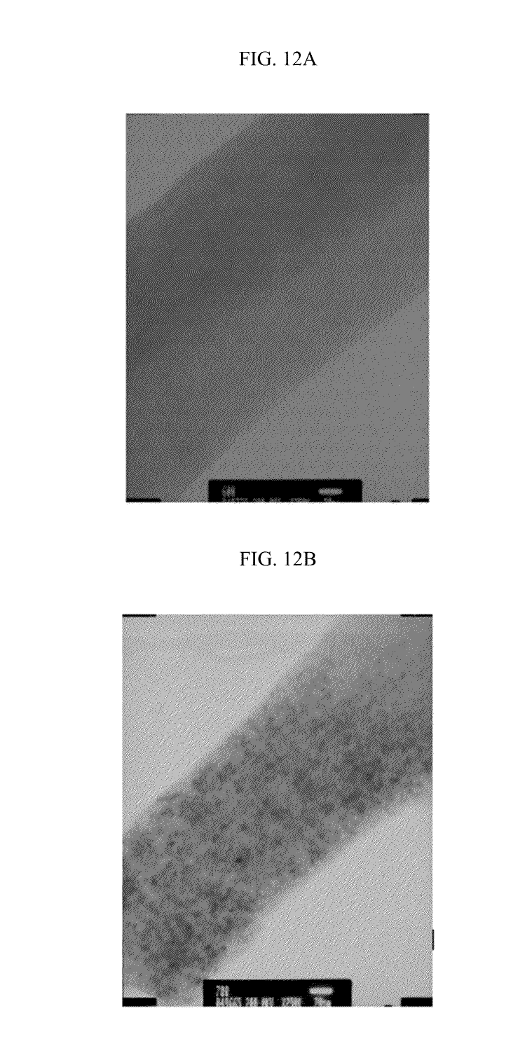

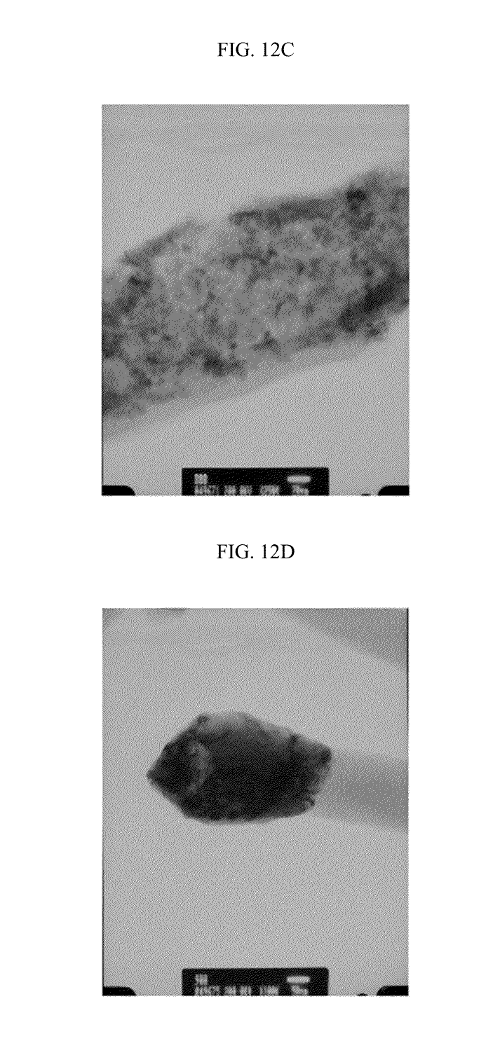

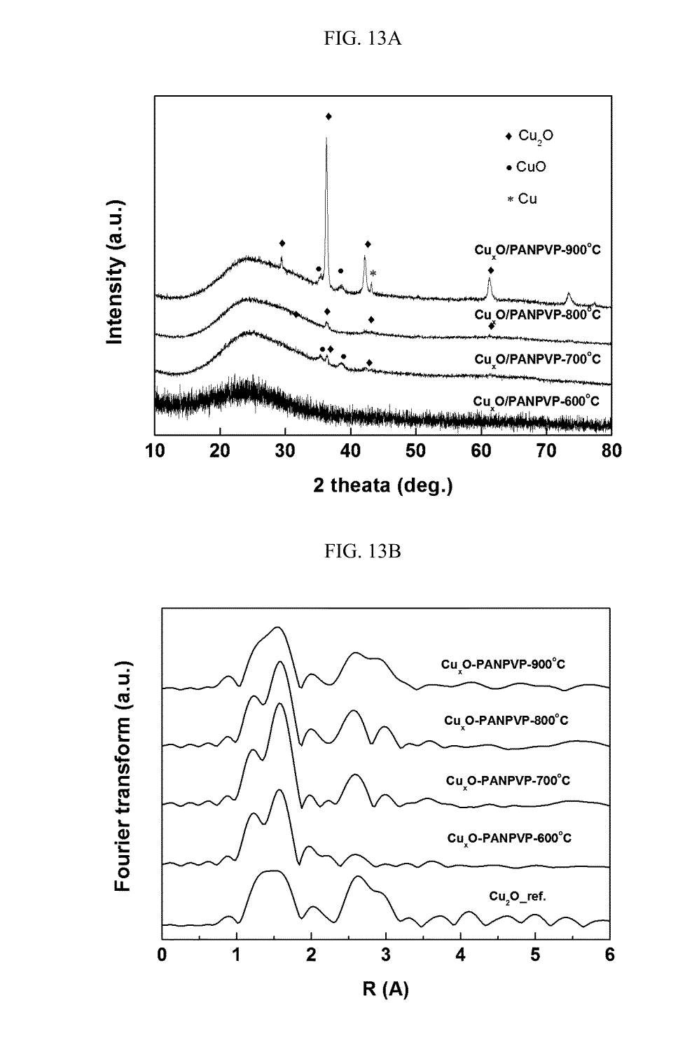

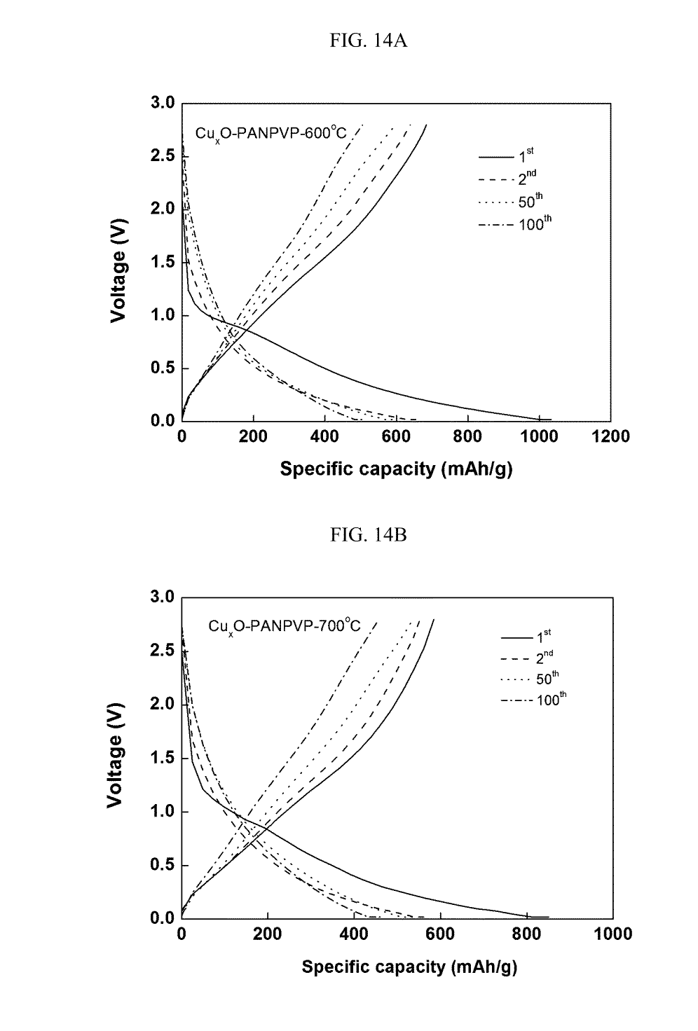

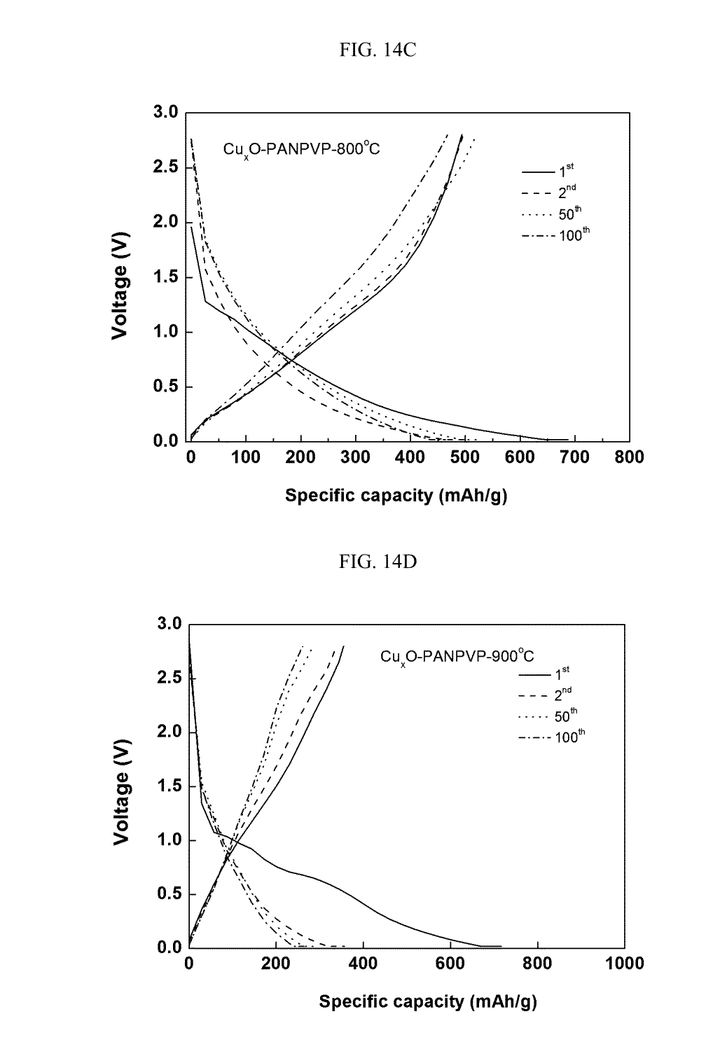

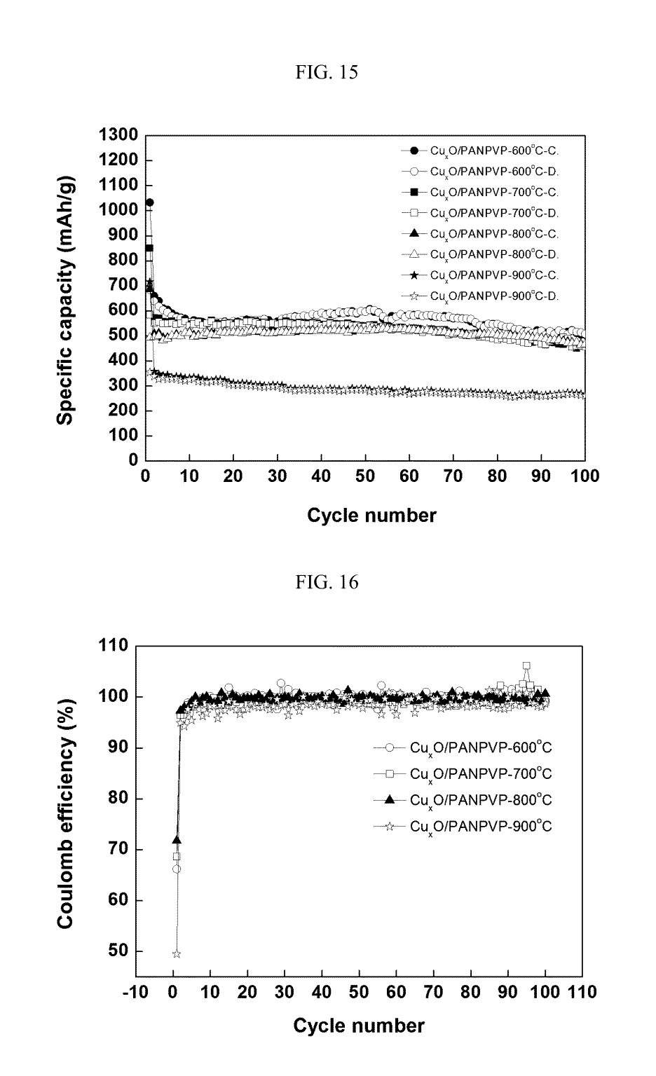

The SEM images of the copper oxide-containing carbon nanofiber (Cu₂O_PANPVP_CNF) manufactured at each of the temperatures described above are shown in FIGS. 11A, 11B, 11C, and 11D. In addition, TEM images of the copper oxide-containing carbon nanofiber are shown in FIGS. 12A, 12B, 12C, and 12D, a degree of crystallization of the copper oxide-containing carbon nanofiber is shown in FIG. 13A, and a fine structure analysis using the x-ray absorption spectroscope of the copper oxide is shown in FIG. 13B. In addition, FIGS. 14A, 14B, 14C, and 14D show the charge and discharge results of an electrode when the copper oxide-containing carbon nanofiber was used as the electrode. In addition, FIG. 15 shows a cycle characteristic when the copper oxide-containing carbon nanofiber was used as an anode, and FIG. 16 shows a Coulomb efficiency.

### FOURTH EXAMPLE

0.8 g of a polyacrylonitrile resin (weight-average molecular weight: 150,000) was added to a 9 g N,N-dimethylformamide solvent and was dissolved for 5 hours at 120° C. to produce a polymer solution (B). 0.2144 g of a copper (II) acetate was added to the polymer solution (B) at room temperature and was agitated for 3 hours at 120° C. again.

The homogenized copper (II) acetate/polyacrylonitrile polymer solution was electrospun using an electrospinning device. Hereinafter, the electrospinning conditions are the same as those in the third example.

The separated fiber web made of the copper (II) acetate/polyacrylonitrile was subjected to heat treatment for 5 hours under an air atmosphere at 230° C. In this case, the temperature was increased by 1° C. per minute and was maintained at 230° C. for 5 hours.

After heat treatment process was carried out, the carbonization process was carried out for 1 hour at 800° C.

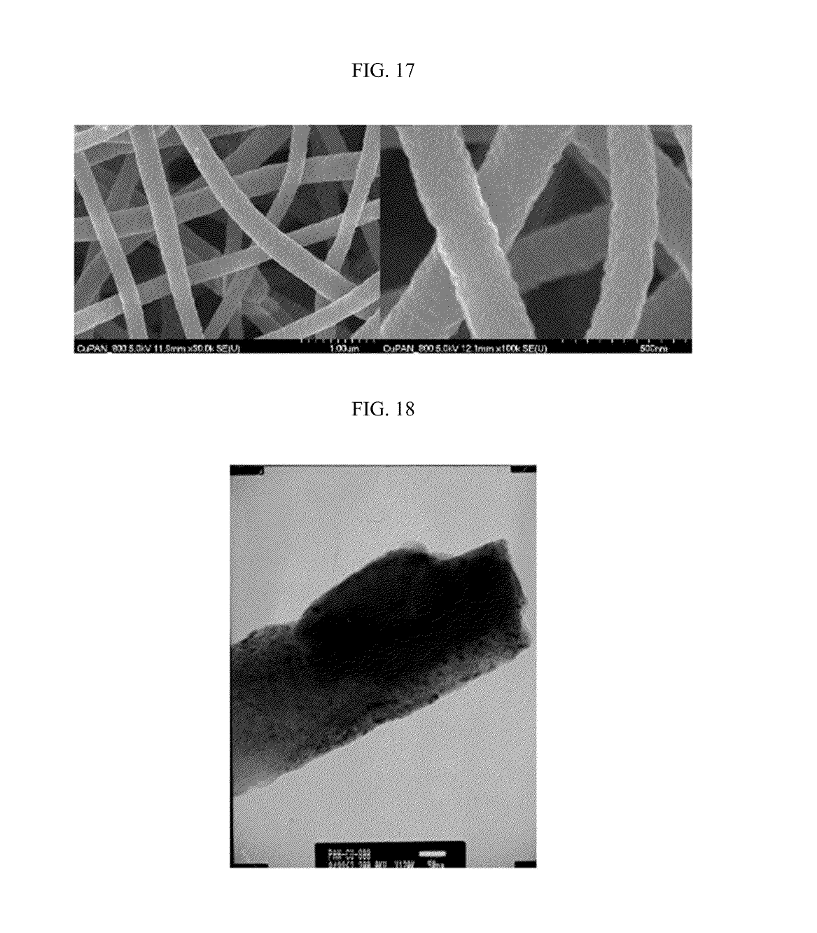

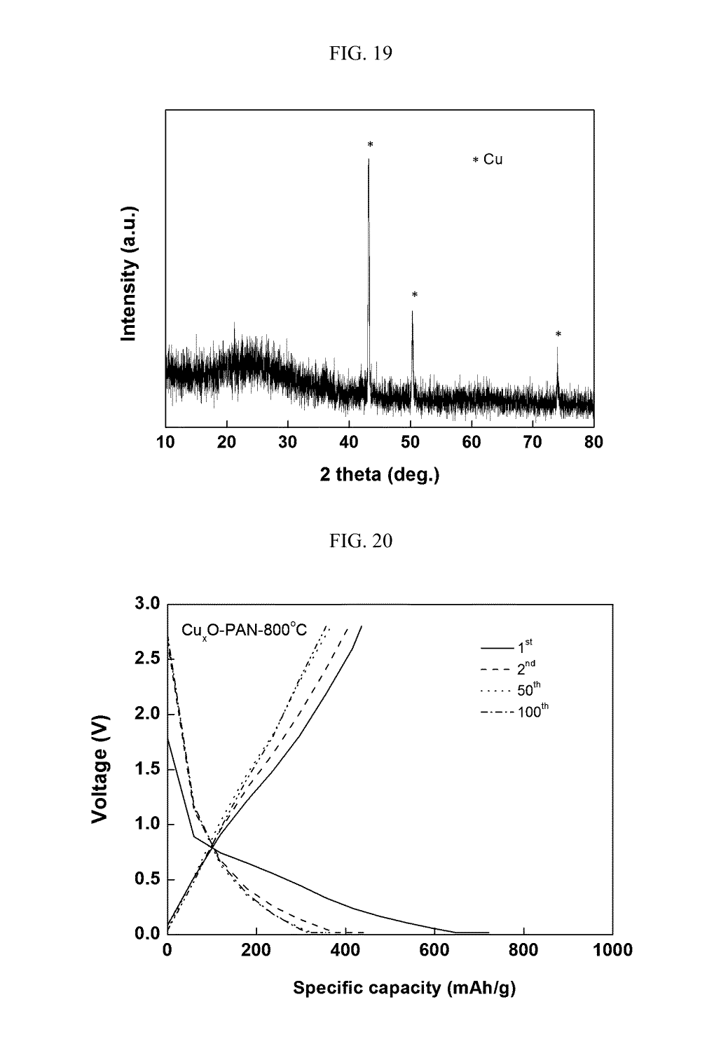

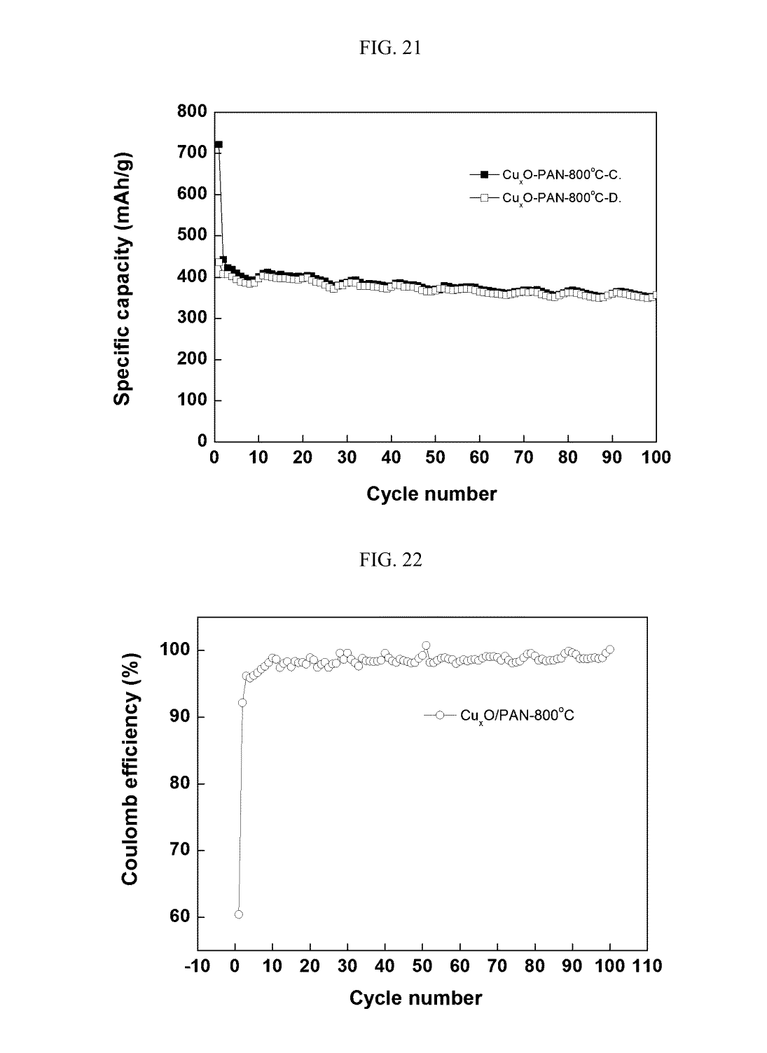

The SEM images of the copper and copper oxide-containing carbon nanofiber (CuₓO-PAN-800° C.) manufactured as described above is shown in FIG. 17. In addition, the TEM image of the copper and copper oxide-containing carbon nanofiber is shown in FIG. 18, a degree of crystallization of the copper and copper oxide-containing carbon nanofiber is shown in FIG. 19, and charge and discharge cycle characteristics of an electrode when the copper and copper oxide-containing carbon nanofiber was used as the electrode are shown in FIG. 20. In addition, FIG. 21 shows a cycle characteristic when the copper and copper oixedcontaining carbon nanofiber was used as an anode, and FIG. 22 shows a Coulomb efficiency.

As shown in FIGS. 11A, 11B, 11C, and 11D, it was found that a diameter of the fiber was 200 nm at 600° C. and was decreased when the temperature was increased. An average diameter of the copper oxide-containing carbon nanofiber produced by the methods of the present invention was about 150 nm, and a range of the fiber diameter was 100 to 200 nm. It can be seen that the diameter of the fiber is one fiftieth or less of the diameter of about 10 μm of the fiber produced by a general fiber manufacturing method such as a melt spinning method, and the fiber is produced as a superfine fiber thinner than an active carbon nanofiber produced by spinning polyacrylonitrile only. In addition, as seen from FIGS. 12A, 12B, 12C, and 12D it was found that the size of the copper oxide and the degree of dispersion within the carbon nanofiber were changed depending on each temperature. The copper oxide structure did not develop well within the carbon nanofiber at 600° C. (FIG. 12A) and developed in a nano size of about 1 nm on a surface of the fiber at 700° C. (FIG. 12B). In addition, it was found that the copper oxides developed to about 2 to 5 nm at 800° C. (FIG. 12C) and were significantly aggregated to be 50 nm or more at 900° C. (FIG. 12D). Accordingly, it was found that a suitable temperature needs to be applied in order to properly disperse the copper oxides within the carbon nanofiber.

Two theories are mainly employed for a sintering phenomenon of the metal or metal oxide depending on the temperature as described above. One of them is that the whole crystallites move on a surface of a carrier to be aggregated due to a collision (crystallite movement mechanism), and the other is that metal atoms (or molecules) are separated from the crystallites to collide with and become entrapped by crystallites (atom movement mechanism). Since the sintering of the metal or metal oxide reduces a surface area of the particle, preventing the sintering in a case of the electrode material of the secondary battery or the catalyst usually subjected to a surface reaction directly affects the performance of the battery. Factors influencing the sintering during the procedure of manufacturing the material include a temperature, a time, a metal loading, an ambient gas, an initial distribution of the metal particle size, a carrier, or the like. The metal particles can be prevented from being sintered by properly adjusting the metal loading, the temperature, the heat treatment time, and so forth.

According to the present invention, the temperature was properly adjusted to manufacture the carbon nanofiber in which the nano-sized copper oxides were evenly dispersed and the carbon nanofiber was used as the anode material of the lithium secondary battery, thereby suppressing the sintering phenomenon even when the copper oxides were subjected to the charge and discharge procedure.

FIG. 13A shows the degree of crystallization of the copper oxide-containing carbon nanofiber, and FIG. 13B shows the fine structure. In the case of the copper oxides dispersed within the carbon nanofiber, the copper oxides are dispersed several nanometers into the carbon nanofiber, and it is thus difficult to carry out exact structure analysis with the X-ray diffraction analysis. Accordingly, the fine structure analysis using the X-ray absorption spectroscope needs to be carried out with the X-ray diffraction analysis at the same time. It can be seen from the X-ray diffraction analysis that the peak position and the peak intensity associated with the crystalline property of the copper oxide are changed as the temperature is increased. No peak associated with the copper oxide was detected in the carbon nanofiber produced at 600° C. and small peaks associated with CuO (copper (II) oxide) and Cu₂O (copper (I) oxide) were detected in the carbon nanofiber produced at 700° C. In addition, only a peak associated with Cu₂O was detected in the carbon nanofiber produced at 800° C., and small peaks associated with Cu and CuO, in addition to the very high peak of the crystalline Cu₂O, were detected due to the decomposition of Cu₂O in the sample produced at 900° C. It was confirmed from the fine structure analysis that an amorphous copper oxide was formed at 600° C., CuO in a disordered form was formed at 700° C., an intermediate structure between CuO and Cu₂O in the disordered form was formed at 800° C., and a structure of Cu₂O was developed at 900° C.

FIGS. 14A, 14B, 14C, 14D, and 15 show the charge and discharge results and cycle characteristics when the copper oxide-containing carbon nanofiber produced at each temperature was used as the anode of the secondary battery. As can be seen from the charge and discharge results, it was found that the copper oxide-containing carbon nanofiber produced at 800° C. has the smallest irreversible capacity for 100 cycles of charge and discharge procedure. This seems to be because the particle size of the copper oxide is small and the carbon nanofiber has the high electrical conductivity even when Li₂O is created by inserting the Li ions into the copper oxide to accelerate decomposition of Li₂O and prevent the volume expansion, thereby exhibiting the best cycle characteristics.

FIG. 16 shows the Coulomb efficiency, and the copper oxide-containing carbon nanofiber produced at 800° C. exhibited the best Coulomb efficiency at the first cycle, which is the same as described above.

FIG. 17 shows an SEM image of the copper and copper oxide-containing carbon nanofiber (CuₓO-PAN-800° C.) produced by electrospinning the copper (II) acetate/polyacrylonitrile solution, heat treating the same, and then carbonizing the same at 800° C. as is done in the fourth example.

It was found in FIG. 18 that the diameter of the carbon fiber spun with only polyacrylonitrile was 250 nm, which was greater than the diameter of the sample spun with polyvinylpyrrolidone being added thereto. In addition, it was found from the TEM image of FIG. 18 that very big particles were present not inside the carbon nanofiber but outside the carbon nanofiber. This differs from the sample produced with polyvinylpyrrolidone being added thereto as is done in the third example, and it can be seen that polyvinylpyrrolidone acts to more evenly disperse the copper oxide particles within the carbon nanofiber.

FIG. 19 is a graph illustrating a degree of crystallization of the copper and copper oxide-containing carbon nanofiber produced by mixing copper (II) acetate and polyacrylonitrile, and it can be confirmed that copper is present in a metal state as well as oxide state and the crystalline property thereof is significantly developed.

FIG. 20 shows the charge and discharge cycle characteristics of the copper-containing carbon nanofiber produced by mixing copper (II) acetate and polyacrylonitrile. As can be seen from FIGS. 20 and 21, it can be seen that the carbon nanofiber produced by mixing only polyacrylonitrile has the copper metal formed inside of it, and the capacity is thus decreased as the cycle progresses when the carbon nanofiber is used as the anode.

In addition, it can be seen from FIG. 22 that the Coulomb efficiency of the copper copper oxide-containing carbon nanofiber produced by mixing copper (II) acetate and polyacrylonitrile is also lower than that of the carbon nanofiber with polyvinylpyrrolidone being added thereto. As described above, it can be concluded that the electrochemical sites are increased by highly dispersing the copper oxides when polyvinylpyrrolidone is added, the electrical conductivity of the carbon nanofiber is kept even when Li₂O is created during the charge and discharge procedure, and the aggregation of the copper oxides is buffered, so that the electrochemical property is very good.

Accordingly, it is possible to manufacture the copper oxide-containing carbon nanofiber having good enough electrochemical characteristics to replace the existing graphite as an anode of the lithium secondary battery by adjusting whether a compound having an oxygen atom as a donor atom such as polyvinylpyrrolidone needs to be added, a content of the carbon precursor material and polyvinylpyrrolidone at the time of electrospinning, and a content of the copper precursor in accordance with an aspect of the embodiments.

<Manufacturing Intermetallic Compound-Containing Carbon Nanofiber and Analyzing Characteristics Thereof>

### FIFTH EXAMPLE

0.4 g of a polyacrylonitrile resin (weight-average molecular weight: 150,000) and 0.4 g of a polyvinylpyrrolidone resin (molecular weight: 1,300,000) were added to a 9 g N,N-dimethylformamide solvent and were dissolved for 5 hours at 120° C. to produce a polymer solution (A). Tin (II) acetate (molecular weight: 236.78), copper (II) acetate (molecular weight: 181.64), antimony (III) acetate (molecular weight: 298.84), and nickel (II) acetate (molecular weight: 248.84) were mixed in mole ratios of Ni₃Sn₂ (3:2 mol), SnSb (1:1 mol), and Cu₆Sn₅ (6:5) and were added to the polymer solution (A) at room temperature and agitated for 5 hours at 120° C. again.

TABLE 1

| | weight (g) | | | | |
|---|---|---|---|---|---|
| intermetallic | | | copper | antimony | Mixed |
| compound | tin acetate | nickel acetate | acetate | acetate | weight |
| Ni₃Sn₂ | 0.0629 | 0.0991 | | | 0.162 |
| Cu₆Sn₅ | 0.0832 | | 0.0766 | | 0.159 |
| SnSb | 0.0541 | | | 0.068 | 0.122 |

The homogenized tin (II) acetate, copper (II) acetate, antimony (III) acetate, and nickel (II) acetate were added to a polyacrylonitrile/polyvinylpyrrolidone solution, homogenized, and then electrospun using an electrospinning device. In this case, the spinning conditions were such that the fiber precursor solution was introduced into a 10 ml syringe with a 0.5 mm needle of and the electrospinning was carried out by applying a voltage of 20 kV. In this case, a distance between the needle and the current collector was maintained at 17 cm, an elution speed of the fiber precursor solution was 1 ml/h, and the non-woven fabric was removed when the fibers were integrated in the current collector.

The separated fiber web made of the tin (II) acetate/copper (II) acetate, tin (II) acetate/antimony (III) acetate, tin (II) acetate/nickel (II) acetate, and polyacrylonitrile/polyvinylpyrrolidone was oxidatively stabilized for 5 hours under an air atmosphere at 280° C. In this case, the temperature was increased by 1° C. per minute and was kept for 5 hours at 280° C.

After the oxidative stabilization was sufficiently carried out, the carbonization process was carried out for 1 hour at each of 600° C., 700° C., and 800° C.

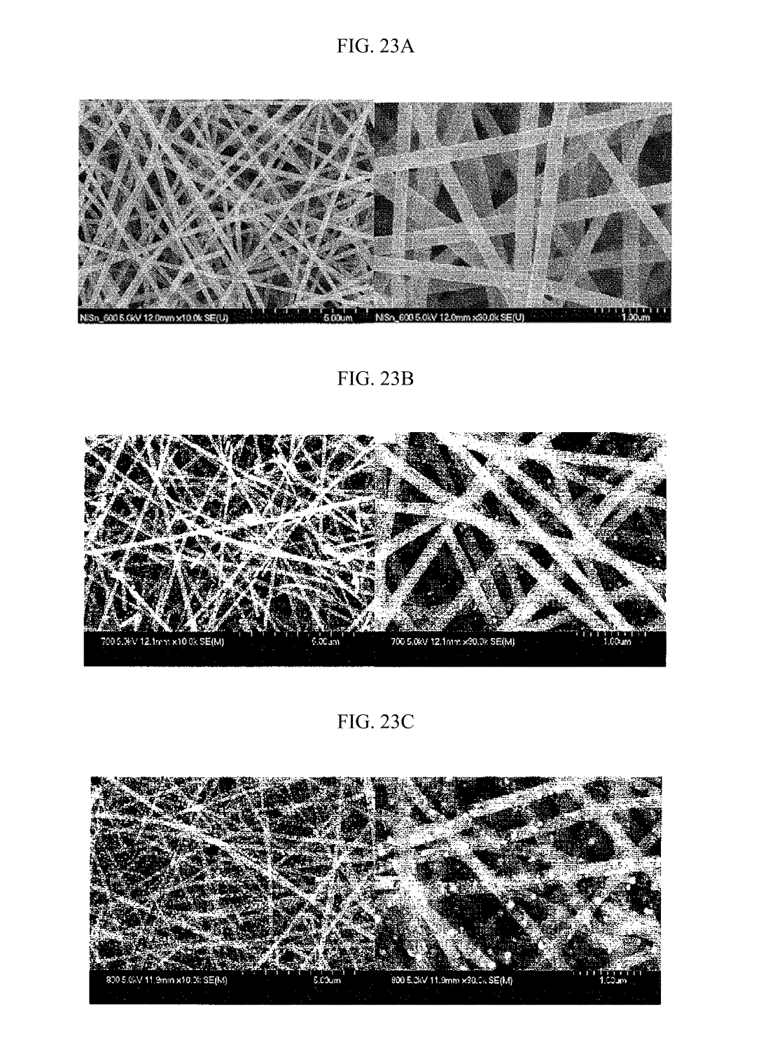

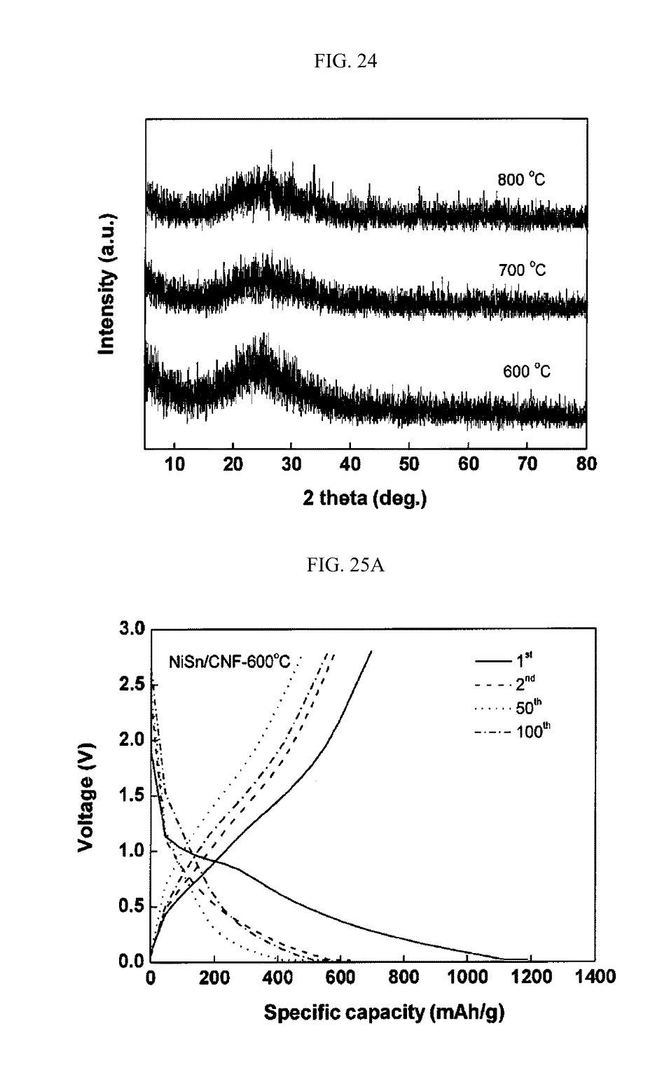

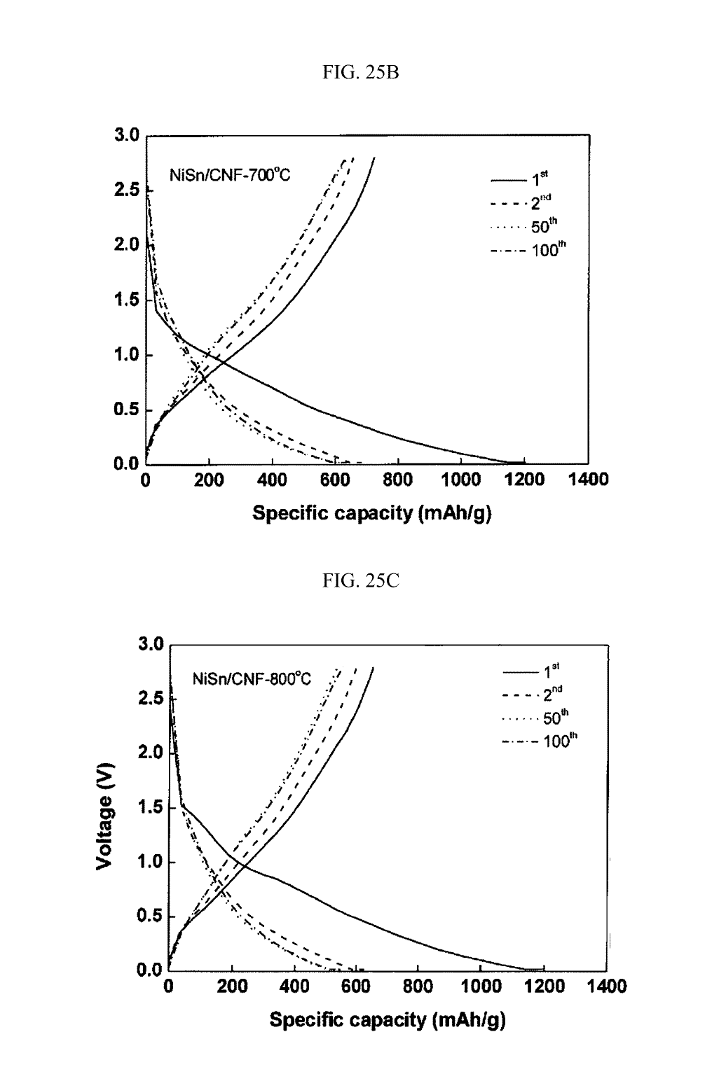

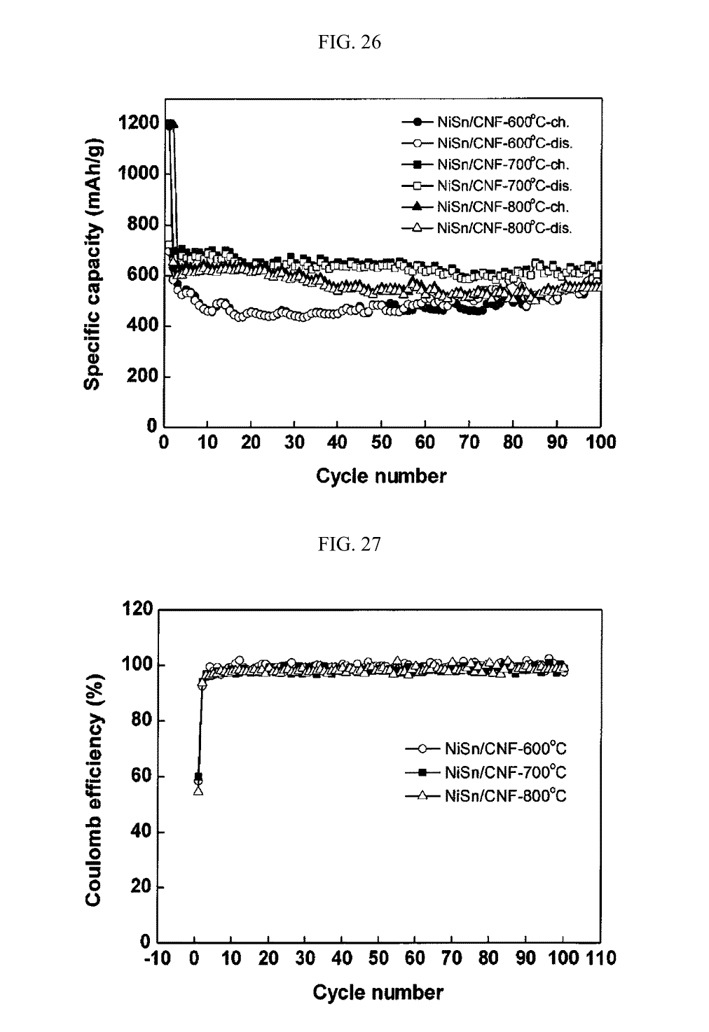

The SEM images of the Ni₃Sn₂-containing carbon nanofiber produced at each of the temperatures are shown in FIGS. 23A, 23B, and 23C. In addition, the degree of crystallization of the Ni₃Sn₂-containing carbon nanofiber produced at each temperature is shown in FIG. 24, and the charge and discharge results of an electrode when the Ni₃Sn₂-containing carbon nanofiber was used as the electrode are shown in FIGS. 25A, 25B, and 25C. In addition, FIG. 26 shows the cycle characteristics when the nanofiber is used as an anode, and FIG. 27 shows the Coulomb efficiency.

As can be seen in FIGS. 23A, 23B, and 23C, the diameter of the fiber is about 200 nm at 600° C., 700° C., and 800° C., and particles are aggregated markedly as the temperature is increased. It can be seen that the diameter of the fiber is one fiftieth or less of the diameter of about 10 μm of the fiber produced by a general fiber manufacturing method such as a melt spinning method, a solution spinning method, and a gel state spinning method, and the fiber is produced as a superfine fiber thinner than an active carbon nanofiber produced by spinning only polyacrylonitrile. Since the aggregation of particles depending on the temperature of the metal or intermetallic compound, that is, the sintering, decreases the surface area of the particle, preventing the sintering directly affects the performance enhancement in the case of the electrode material of the secondary battery or the catalyst usually subjected to a surface reaction. Accordingly, it is preferable to prevent the intermetallic compound from being sintered by appropriately adjusting the metal loading, the temperature, the heat treatment time, and so forth. In this case, it is decided that the intermetallic compound-containing carbon nanofiber of the present invention prevents the sintering as compared to a case of producing only the intermetallic compound even when the temperature is increased. In addition, when the carbon nanofiber in which the nano-sized intermetallic compounds are evenly dispersed by appropriately adjusting the temperature is used as the anode material of the lithium secondary battery, the aggregation of particle seems to be suppressed even when the charge and discharge procedure progresses.

As can be seen in FIG. 24, the degree of crystallization is changed depending on the temperature, and is increased as the temperature is increased. This means that the proper temperature condition directly affects the degree of crystallization of the intermetallic compound. In addition, in consideration of detected peaks of a small amount of the tin oxides and the intermetallic compound at 800° C., it can be seen that the content of the tin oxide and the intermetallic compound can be appropriately adjusted in accordance with the temperature condition.

According to the results shown in FIG. 24, production of the tin oxide means that precursors were mixed in a predetermined mole ratio to try to produce Ni₃Sn₂ with only a single phase, but the Ni₃Sn₂ single phase was not formed within the polymer solution even when polyvinylpyrrolidone was added. Typically, it is reported that the single phase of Ni₃Sn₂ is formed well when Ni and Sn precursors are added to a predetermined solvent and are agitated for 6 hours or more at 200° C. or higher. However, at the time of manufacturing the intermetallic compound-containing carbon nanofiber according to the present invention, metal precursors were added into a mixed polymer solution of polyacrylonitrile/polyvinylpyrrolidone and were heated to 200° C. or higher, which caused a solvent of DMF to be evaporated and the polymer to be decomposed, and it is thus difficult to form the single phase of Ni₃Sn₂. Accordingly, it seems that Ni₃Sn₂, Ni, Sn, NiO, SnO₂, or the like will be present within the carbon nanofiber. Hereinafter, this applies to other intermetallic compounds as well.

FIGS. 25 and 26 show the charge and discharge results and the cycle characteristics when the Ni₃Sn₂-containing carbon nanofiber produced at each temperature was used as an anode of the secondary battery. As can be seen from the charge and discharge results, the intermetallic compound-containing carbon nanofiber produced at 700° C. had the smallest irreversible capacity for 100 cycles of the charge and discharge procedure. This seems to be because the particle size of Ni₃Sn₂ is small at 700° C. and the carbon nanofiber has electrical conductivity even when Li₂O is created by inserting the Li ions into NiO and SnO₂to exhibit the best cycle characteristics. However, the poor cycle characteristics at 800° C. or higher seem to be because the particles are aggregated to cause the charge and discharge of the Li ions to be inactively carried out. FIG. 27 shows the Coulomb efficiency, and the carbon nanofiber produced at 700° C. also exhibits the best Coulomb efficiency at the first cycle, which is the same as described above.

Several papers and patents in which a mutual reaction between polyvinylpyrrolidone and metal cations, metal reduction using polyvinylpyrrolidone, electrospinning using polyvinylpyrrolidone, and mixing polyacrylonitrile with metal precursors are described have been published. However, research on the intermetallic compound-containing carbon nanofiber produced by mixing metal precursors in a predetermined mole ratio and adding the metal precursors to a polymer solution in which polyacrylonitrile and polyvinylpyrrolidone are mixed has not been conducted yet. In addition, there are no examples of using the intermetallic compound and the carbon nanofiber for the anode of the secondary electrode.

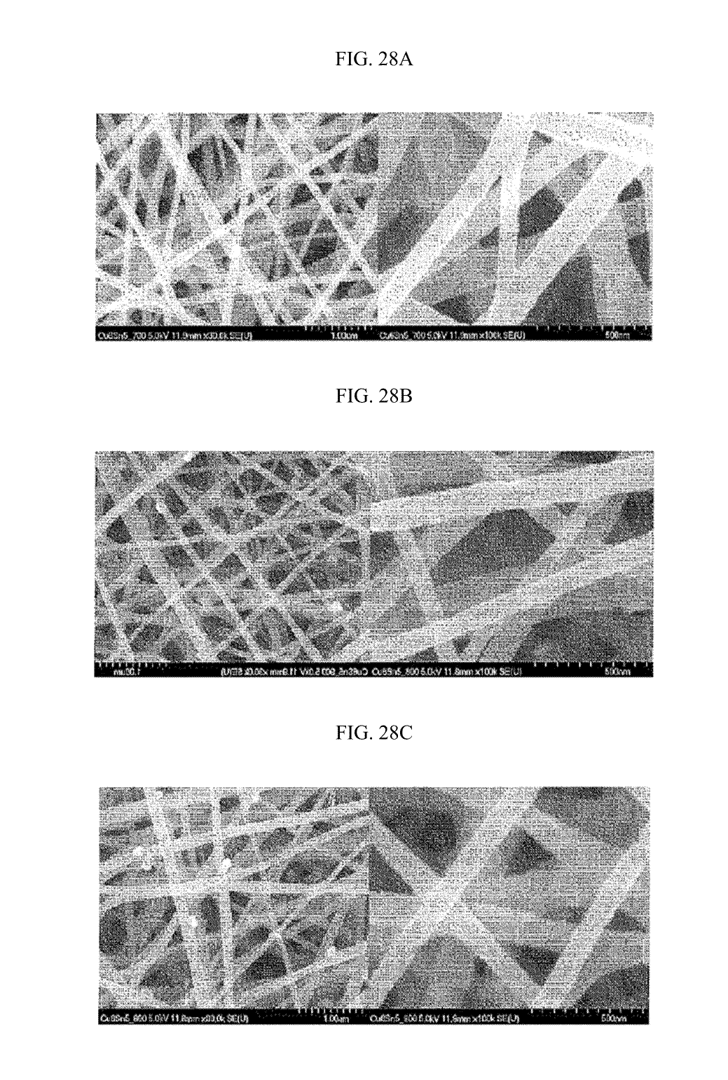

FIG. 28 shows the SEM image of the Cu₆Sn₅-containing carbon nanofiber produced in the fifth example depending on the temperature. It can be confirmed in FIG. 28 that the fiber diameter of the Cu₆Sn₅-containing carbon nanofiber produced at 700° C. was about 200 nm, was decreased when the temperature was increased to 800° C. and 900° C., and was 100 nm at 900° C.

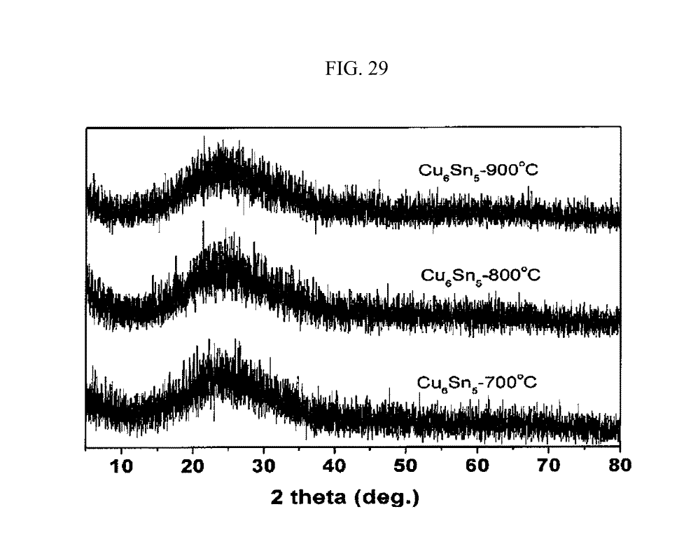

FIG. 29 shows the degree of crystallization of the Cu₆Sn₅-containing carbon nanofiber produced at each temperature, and it can be seen that the crystallization did not progress even when the heat treatment was carried out at 900° C. This is because production of the intermetallic compound is not easy due to a difference in ion radius between the tin and copper cations to cause the degree of crystallization not to be increased even when the temperature is increased.

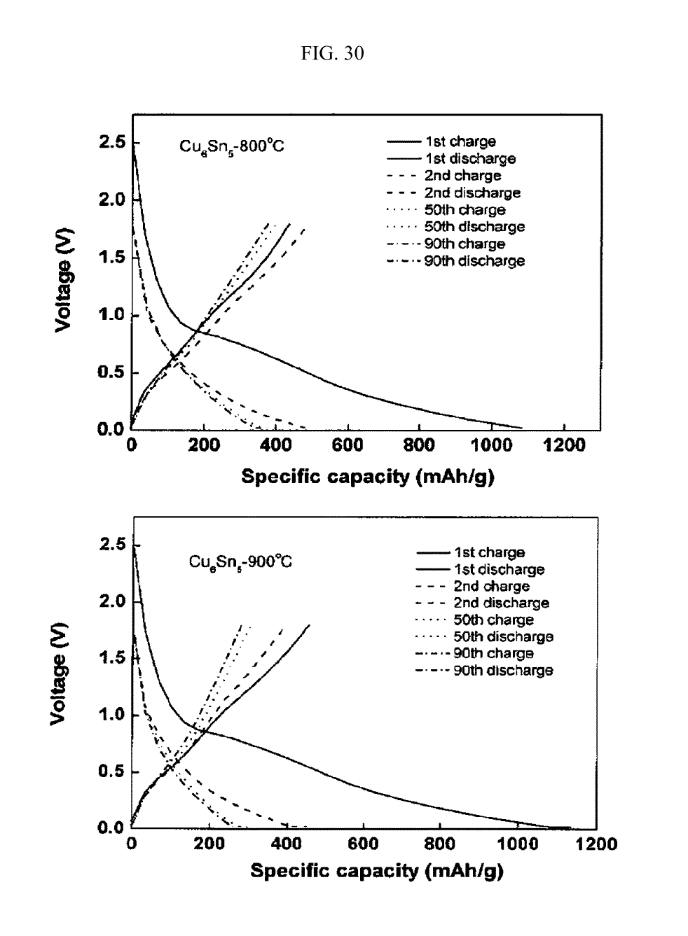

FIG. 30 is a charge and discharge graph of the Cu₆Sn₅-containing carbon fiber, and it can be seen that the charge and discharge capacity of Cu₆Sn₅-containing carbon fiber was decreased when the temperature was increased to 800° C. and 900° C.

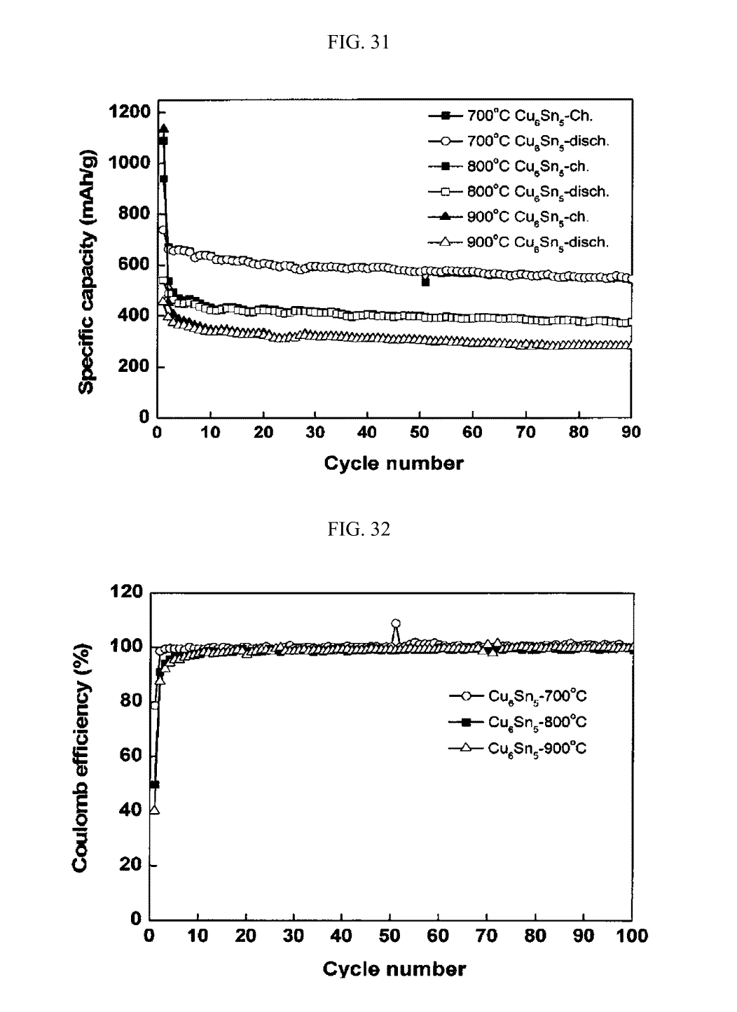

FIGS. 31 and 32 show the cycle characteristics and the Coulomb efficiency, respectively. It can be seen that the Cu₆Sn₅-containing carbon fiber produced at 700° C. has the best cycle characteristics and Coulomb efficiency. It can thus be seen that a proper temperature condition at the time of producing the Cu₆Sn₅-containing carbon fiber affects the cycle stability, the charge and discharge performance, and the Coulomb efficiency when the fiber is used as an anode of the lithium secondary battery.

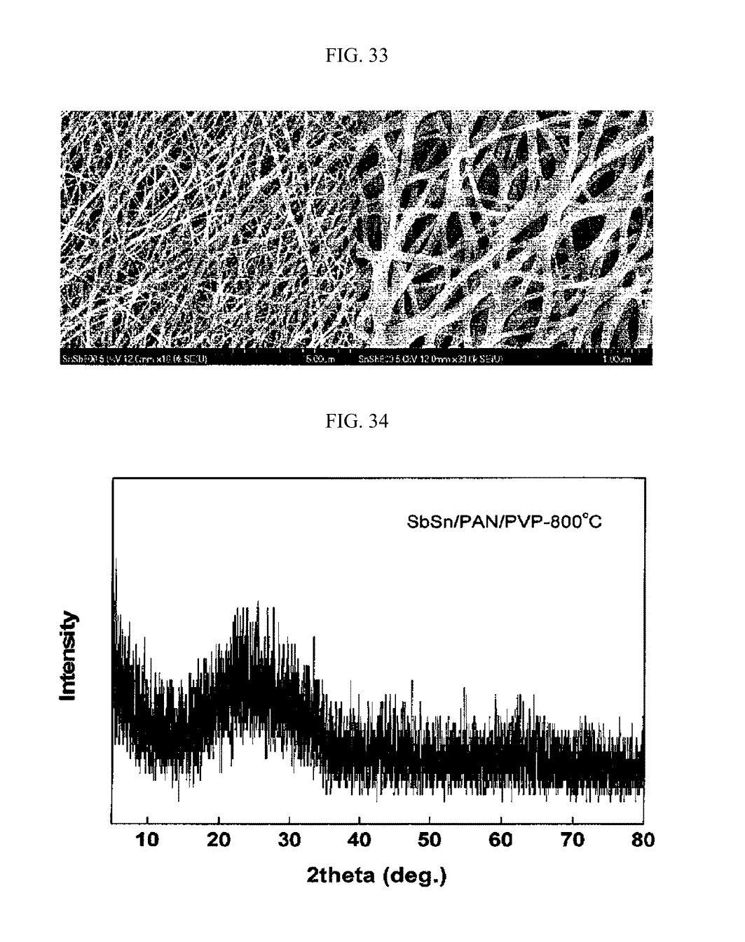

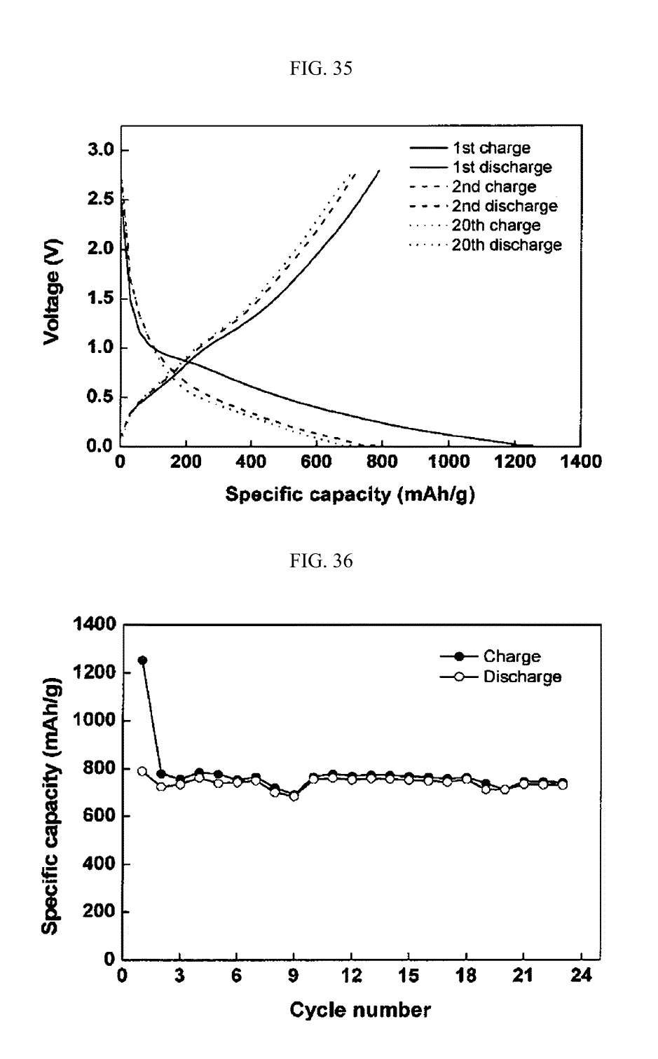

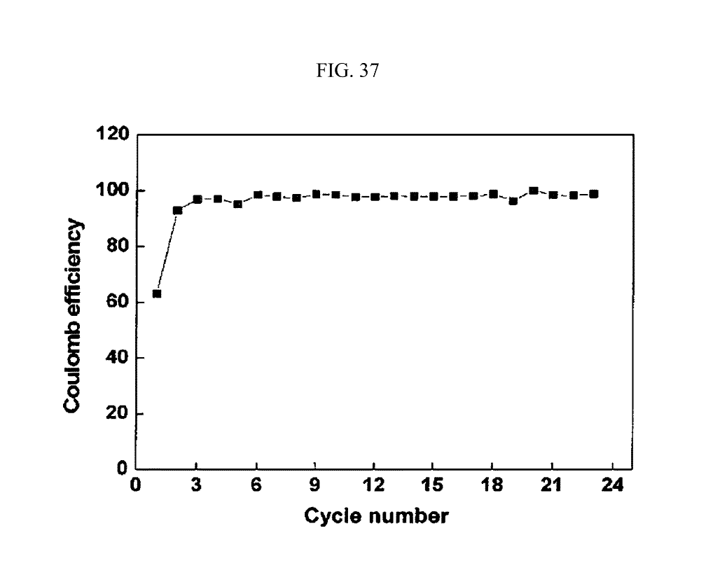

In addition, FIG. 33 shows the SEM image of the SnSb-containing carbon nanofiber produced at 800° C. FIG. 34 shows the degree of crystallization of the SnSb-containing carbon nanofiber produced at 800° C. FIG. 35 shows the charge and discharge results of an electrode when the SnSb-containing carbon nanofiber is used as the electrode. In addition, FIG. 36 shows the cycle characteristics when the nanofiber is used as an anode, and FIG. 37 shows the Coulomb efficiency.

As can be seen in FIG. 33, the aggregation of the particles is decreased even when the temperature reaches 800° C. and the fiber having a diameter of about 200 nm or less can be produced well without beads. As can be seen in FIGS. 34 and 35, the degree of crystallization does not significantly develop and the charge and discharge characteristics when the fiber is used as a lithium anode are very good. Since this is an incomparably superior result to the result of the existing SnSb compound, there is a high probability of it replacing the existing graphite. FIG. 36 shows the cycle characteristics of the SnSb-containing carbon nanofiber, in particular, high charge and discharge cycle characteristics of 780 mAh/g or more. In addition, FIG. 37 is a graph illustrating the Coulomb efficiency of the SnSb-containing carbon nanofiber, and it can be seen that the first Coulomb efficiency is 60 or more, which is better than that of the existing SnSb compound.

Therefore, as described above from the results, it can be concluded that the intermetallic compound-containing carbon nanofiber enables the intermetallic compounds to be highly dispersed, the highly dispersed intermetallic compounds increase electrochemically active sites, and inert metals of the intermetallic compounds buffer the aggregation even when the charge and discharge procedure progresses, so that the carbon nanofiber exhibits very good characteristics as an anode material of the lithium secondary battery.

Therefore, the intermetallic compound-containing carbon nanofiber produced by the methods of the present invention exhibits an electrochemically good characteristic enough to replace the existing graphite as an anode of the lithium secondary battery.

1-15. (canceled)

16. A method of manufacturing a metal oxide-containing carbon nanofiber, comprising:
adding a tin precursor or a copper precursor to a carbon fiber precursor material to manufacture a fiber precursor composite;
spinning the fiber precursor composite to manufacture a fiber; and
heat treating the fiber.

17. The method according to claim 16, further comprising:
carbonizing the heat treated fiber; and
activating the carbonized fiber.

18. The method according to claim 16, wherein the fiber precursor composite further includes a polyvinylpyrrolidone resin.

19. The method according to claim 16, wherein the fiber precursor composite further includes a compound having an oxygen atom as a donor atom.

20. The method according to claim 19, wherein the compound having oxygen atom as the donor atom includes any one or more functional groups selected from RO—, —C═O—, —CO—, —SO—, —O—R—CO—, —O—R—O—, —OCR—CO—, —NH—R—CO—, and —NH—R—O— (where R is an alkyl group of C1 to C20, or an aryl group or a substituted aryl group of C6 to C20).

21. The method according to claim 16, wherein the carbon fiber precursor material includes any one selected from the group consisting of polyacrylonitrile, polyfurfuryl alcohol, cellulose, glucose, polyvinyl chloride, polyacrylic acid, polylactic acid, polyethylene oxide, polypyrrole, polyimide, polyamide imide, polyaramide, polybenzimidazole, polyaniline, phenol resin, and pitch, or a mixture of at least two selected from the group.

22. The method according to claim 16, wherein heat treating the fiber is carried out for 0.5 to 5 hours at a final temperature after a temperature is increased from room temperature to a temperature of 200° C. to 300° C. by 0.1 to 10° C. per minute under an air atmosphere.

23. The method according to claim 16, wherein the fiber precursor composite has a solid content of 5 to 50 weight %.

24. The method according to claim 16, wherein the tin precursor is one or more selected from a tin nitrate, a tin chloride salt, a tin acetate, a tin alkoxide, or a mixture thereof.

25. The method according to claim 16, wherein the copper precursor is one or more selected from a copper nitrate, a copper chloride salt, a copper acetate, a copper alkoxide, or a mixture thereof.

26. The method according to claim 16, wherein a solvent of the composite is any one selected from the group consisting of N,N-dimethylformamide (DMF), dimethylacetamide (DMAc), tetrahydrofuran (THF), dimethylsulfoxide (DMSO), gamma-butyrolactone, N-methylpyrrolidone, chloroform, toluene, and acetone, or a mixture of at least two selected from the group.

27. A lithium secondary battery electrode material using a composite fiber web consisting of a carbon nanofiber manufactured by the method according to claim 16.

28. A method of manufacturing an intermetallic compound-containing carbon nanofiber, comprising:
adding at least two metal precursors to a carbon fiber precursor material to manufacture a fiber precursor composite;
spinning the fiber precursor composite to manufacture a fiber; and
heat treating the fiber.

29. The method according to claim 28, further comprising:
carbonizing the heat treated fiber; and
activating the carbonized fiber.

30. The method according to claim 28, wherein the fiber precursor composite further includes a polyvinylpyrrolidone resin.

31. The method according to claim 28, wherein the fiber precursor composite further includes a compound having an oxygen atom as a donor atom.

32. The method according to claim 31, wherein the compound having the oxygen atom as the donor atom includes any one or more functional groups selected from RO—, —C═O—, —CO—, —SO—, —O—R—CO—, —O—R—O—, —OC—R—CO—, —NH—R—CO—, and —NH—R—O— (where R is an alkyl group of C1 to C20, or an aryl group or a substituted aryl group of C6 to C20).

33. The method according to claim 28, wherein the carbon fiber precursor material includes any one selected from the group consisting of polyacrylonitrile, polyfurfuryl alcohol, cellulose, glucose, polyvinyl chloride, polyacrylic acid, polylactic acid, polyethylene oxide, polypyrrole, polyimide, polyamide imide, polyaramide, polybenzimidazole, polyaniline, phenol resin, and pitch, or a mixture of at least two selected from the group.

34. The method according to claim 28, wherein heat treating the fiber is carried out for 0.5 to 5 hours at a final temperature after a temperature is increased from room temperature to a temperature of 200° C. to 300° C. by 0.1 to 10° C. per minute under an air atmosphere.

35. The method according to claim 28, wherein the fiber precursor composite has a solid content of 5 to 50 weight %.

36. The method according to claim 28, wherein the metal precursor is two or more selected from the group consisting of metal precursors containing tin (Sn), copper (Cu), antimony (Sb), nickel (Ni), iron (Fe), cobalt (Co), titanium (Ti), magnesium (Mg), manganese (Mn), calcium (Ca), zinc (Zn), indium (In), molybdenum (Mo), tungsten (W), aluminum (Al), and silicon (Si) ions.

37. The method according to claim 28, wherein a solvent of the composite is any one selected from the group consisting of N,N-dimethylformamide (DMF), dimethylacetamide (DMAc), tetrahydrofuran (THF), dimethylsulfoxide (DMSO), gamma-butyrolactone, N-methylpyrrolidone, chloroform, toluene, and acetone, or a mixture of at least two selected from the group.

38. A lithium secondary battery electrode material using a composite fiber web consisting of a carbon nanofiber manufactured by the method according to claim 28.
